(19) United States
(12) Patent Application Publication
(10) Pub. No.: US 2023/0312034 A1
(43) Pub. Date: Oct. 5, 2023

(54) BICYCLE WITH INTEGRATED ANTI-THEFT SYSTEM

(71) Applicant: 12226448 CANADA INC., Laval (CA)

(72) Inventor: Bassem GHALY, Laval (CA)

(73) Assignee: 12226448 CANADA INC., Laval, QC (CA)

(21) Appl. No.: 18/023,737

(22) PCT Filed: Aug. 31, 2020
(86) PCT No.: PCT/CA2020/051189

§ 371 Date: Feb. 28, 2023

(51) Int. Cl. B62H 5/10

(52) U.S. Cl. CPC B62H 5/10

(57) ABSTRACT

Bicycle sub-assembly with integrated anti-theft system, for providing a bicycle with an integrated anti-theft capability, the bicycle sub-assembly including a support frame for operatively receiving constituting component(s) of the bicycle, and a blocking assembly being operatively mountable onto the support frame, adjacent to a corresponding bore associated with the support frame for receiving a corresponding spindle of the bicycle, the blocking assembly having at least one blocking mechanism being operatively cooperable with said spindle, the blocking assembly being selectively operable by an authorized user of the bicycle between a first configuration where the at least one blocking mechanism allows the spindle to rotate along an intended mode of the bicycle, and a second configuration where the at least one blocking mechanism operatively interacts with the spindle to prevent it from rotating along the aforementioned intended mode of the bicycle, so as to impede an unauthorized use of the bicycle.

### FIELD OF THE INVENTION

The present invention relates to the field of bicycles and the like. More particularly, and according to a possible intended use, the present invention relates to an anti-theft system, and also relates to a kit with corresponding components for assembling the same, to an assembly and/or sub-assembly (ex. bicycle frame, etc.) and corresponding bicycle provided with such an anti-theft system, and to corresponding methods of manufacturing, assembling and/or operating associated thereto.

### BACKGROUND

Bicycles and other like wheeled vehicles are well known in the art.

Indeed, the bicycle was invented in 1817 (approx.), and this two-wheeled human-powered vehicle was there to stay. Today, people rely on bicycles for transportation, sport, as well as pleasure. Some estimate that there are around 1 billion bicycles in use today. Each year there are around 100 million new bicycles sold (see for example: https://www.bicycle-guider.com/bike-facts-stats/). These figures inspire many questions regarding the mass adoption of bicycles as an essential mode of transportation for short/medium distances.

One of the main problems facing cycling as a mode of transportation today is theft. In the US, around 20 million new bicycles are sold each year (see for example: https://www.statista.com/statistics/236152/us-unit-sales-of-bicycles/). However, around 2 million bicycles are stolen each year (see for example: https://www.bicycling.com/news/a28846575/project-529-bike-theft-data/). In fact, according to a study from Mcgill University, about half of all active cyclists have their bikes stolen (see for example: http://tram.mcgill.ca/Research/Publications/Cycling_theft.pdf). These numbers leave some wondering as to what is the impact of this phenomenon on cycling as a mode of transportation? If the car industry suffered the same problem with the same figures, would the car industry be the same as we know it today? Luckily, the invention of engine immobilizers better protects cars against such crimes.

Bicycle theft figures were not always this severe. In the beginning, a chain and/or lock proved a simple and effective manner against theft. Unfortunately, with modern tools and techniques, thieves today can cut most of these locks in just under a minute. In fact, bicycle theft has become a lucrative activity for thieves looking for fast, easy, and low-risk money. This illegal action hinders the use of bicycles on the same scale as other modes of transportation, delaying our transition to clean and active transportation.

Some improvements, in an attempt try to reduce bicycle theft, have been made over the years.

For example, U.S. Pat. No. 8,689,663 B2, granted on Apr. 8, 2014, to WEBER, relates to a “bicycle pedal with increased theft protection”. Indeed, this document describes an anti-theft bicycle pedal. The mounting end of the pedal is shaped with polygonal faces and/or splines to match an opening on the crank so that when the mounting end of the pedal axle is inserted into the matching opening and locked into place, the pedal cannot be removed without an unlocking agent. With an unlocking agent, the pedal is easily removed without tools. The pedal can be reversibly mounted on the crank so that the bicycle cannot be pedaled away, or so that the pedal can be stowed during transport or storage. The pedal cannot rotate in the crank as a result of polygonal faces and/or splines on the mounting end that resist rotation. A physical stop can be used to control the symmetry of insertion into the opening which facilitates reversible mounting.

U.S. Pat. No. 10,131,390 B2, granted on Nov. 20, 2018, to KALUPNER, relates to an “anti-theft device for a bicycle”. This document describes an anti-theft device for a bicycle which includes a fork unit that has a first fork bar and a second fork bar. The first fork bar has a passage and the second fork bar has a receiving opening. A securing element can be arranged in the fork unit to pass through the first fork bar in the passage and engage in the receiving opening. The securing element passes through a spoke region of a front wheel of the bicycle. The securing element has an engagement contour that engages in the receiving opening. A locking unit with an electromechanical drive is arranged in the second fork bar. The locking unit has a locking contour, which is connected the electromechanical drive and engages in the engagement contour in the locking state. An electronic control unit controls the electromechanical drive to unlock the unit.

U.S. Pat. No. 10,641,007 B2, granted on May 5, 2020, to LI, relates to a “rotary locking mechanism, lock having the same, and locking control method of the lock”. This document describes a rotary locking mechanism and a lock applying the rotary locking mechanism and a locking control method. A rotary output member is locked by a stable triangular supporting structure between the first locking member and the second locking member, the effective constraint of the second locking member on the first locking member applied by the first locking member in both a locked state and an unlocked state achieves locking and unlocking reliability of the product. The entire locking mechanism is controlled by the same switching member. The false locking operation when the rotary member is operating is effectively avoided through the mechanical structure and the automatic control method. The entire rotary locking mechanism is enclosed and fixed in a shell of the lock, and can be applied to transmission machinery of bicycles, electric vehicles, motorcycles and even lightweight automobiles.

U.S. Pat. No. 9,932,759 B2, granted on Apr. 3, 2018, to MOHAMED, relates to a “bicycle security device”. This document describes a bicycle locking device coupled to a bicycle and configured to prevent a wheel from turning. The locking device is configured with a transceiver to communicate with a remote device to receive locking and unlocking indications, and to transmit tampering indications to the remote device. The locking device can generate an audible sound when tampering is detected.

Despite these improvements over the years, there is always a need to continue innovating and finding better and/or different ways of reducing, or at the very least, deterring bicycle theft, and to do so, in a quicker, simpler, more precise, more efficient, more economical, more reliable, more adjustable, more versatile, more adaptable, more durable, more environmentally conscientious, more functional, more sustainable, more desirable, and/or improved manner, than what is possible with the actual way of doing things.

Thus, it would be particularly useful to be able to provide an improved system which, by virtue of its design and components, would be able to overcome or at the very least minimize some of known drawbacks associated with conventional mechanisms and/or methods of securing bicycles.

### SUMMARY OF THE INVENTION

An object of the present invention is to provide an anti-theft system which, by virtue of its design and components, satisfies some of the above-mentioned need(s), and which is thus an improvement over other related anti-theft systems and/or methods known in the prior art.

In accordance with the present invention, the above object is achieved, as will be easily understood from the present description, with an anti-theft system (also referred to herein simply as “system” or “product”) such as the one briefly described herein and such as the one exemplified in the accompanying drawings.

More particularly, according to one aspect of the present invention, an object is to provide an anti-theft system to be integrated onto a corresponding bicycle sub-assembly of a corresponding resulting bicycle, and for providing said bicycle with an integrated anti-theft capability, the anti-theft system comprising:

a blocking assembly being operatively mountable onto the support frame of the bicycle sub-assembly, adjacent to a corresponding bore associated with the support frame for receiving a corresponding spindle of the bicycle, the blocking assembly having at least one blocking mechanism being operatively cooperable with said spindle, the blocking assembly being selectively operable by an authorized user between a first configuration where the at least one blocking mechanism allows the spindle to rotate within the corresponding bore associated with the support frame along an intended mode of the bicycle, and a second configuration where the at least one blocking mechanism operatively interacts with the spindle to prevent said spindle from rotating within the corresponding bore associated with the support frame along the aforementioned intended mode of the bicycle, so as to impede an unauthorized use of the bicycle.

According to another aspect of the present invention, there is provided a vehicle assembly or sub-assembly (ex. a bicycle frame, etc.) provided with the above-mentioned anti-theft system.

For example, and according to another aspect of the present invention, an object is to provide a bicycle sub-assembly with integrated anti-theft system for use with a corresponding bicycle, for providing said bicycle with an integrated anti-theft capability, the bicycle sub-assembly comprising:

a support frame for operatively receiving at least one corresponding constituting component of the bicycle; and

a blocking assembly being operatively mountable onto the support frame, adjacent to a corresponding bore associated with the support frame for receiving a corresponding spindle of the bicycle, the blocking assembly having at least one blocking mechanism being operatively cooperable with said spindle, the blocking assembly being selectively operable by an authorized user of the bicycle between a first configuration where the at least one blocking mechanism allows the spindle to rotate within the corresponding bore associated with the support frame along an intended mode of the bicycle, and a second configuration where the at least one blocking mechanism operatively interacts with the spindle to prevent said spindle from rotating within the corresponding bore associated with the support frame along the aforementioned intended mode of the bicycle, so as to impede an unauthorized use of the bicycle.

According to another aspect of the present invention, there is provided a vehicle (ex. bicycle, etc.) provided with the above-mentioned sub-assembly, frame and/or corresponding anti-theft system.

For example, and according to another aspect of the present invention, an object is to provide a bicycle with integrated anti-theft system, the bicycle comprising:

a support frame for operatively receiving at least one corresponding constituting component of the bicycle, including front and rear wheels being pivotally mounted respectively onto front and rear portions of the support frame;

a pedal assembly operatively mounted about the support frame and being operatively connectable to one of the wheels for driving the bicycle, the pedal assembly having left and right crankarms and associated pedals, and a corresponding spindle operatively interconnecting the left and right crankarms and associated pedals, the spindle being rotatably mounted onto a corresponding bore associated with the support frame; and

a blocking assembly being operatively mounted onto the support frame, adjacent to the corresponding bore associated with the support frame for receiving the corresponding spindle of the bicycle, the blocking assembly having at least one blocking mechanism being operatively cooperable with said spindle, the blocking assembly being selectively operable by an authorized user of the bicycle between a first configuration where the at least one blocking mechanism allows the spindle to rotate within the corresponding bore associated with the support frame along an intended mode of the bicycle, and a second configuration where the at least one blocking mechanism operatively interacts with the spindle to prevent said spindle from rotating within the corresponding bore associated with the support frame along the aforementioned intended mode of the bicycle, so as to impede an unauthorized use of the bicycle.

According to another aspect of the invention, there is also provided a method of assembling and/or mounting the above-mentioned anti-theft system onto a corresponding assembly, sub-assembly, frame and/or vehicle (ex. bicycle, etc.).

According to yet another aspect of the invention, there is also provided a method of using the above-mentioned anti-theft system, assembly, sub-assembly, frame and/or corresponding vehicle (ex. bicycle, etc.).

According to yet another aspect of the invention, there is also provided a kit with components for assembling the above-mentioned anti-theft system, assembly, sub-assembly, frame and/or corresponding vehicle (ex. bicycle, etc.).

According to yet another aspect of the present invention, there is also provided a set of components for interchanging with components of the above-mentioned kit.

According to yet another aspect of the present invention, there is also provided a method of assembling components of the above-mentioned kit and/or set.

According to yet another aspect of the present invention, there is also provided a method of doing business with the above-mentioned anti-theft system, assembly, sub-assembly, frame, resulting vehicle (ex. bicycle, etc.), component(s) thereof, kit, set and/or method(s).

The objects, advantages, and other features of the present invention will become more apparent upon reading of the following non-restrictive description of preferred embodiments thereof, given for the purpose of exemplification only, with reference to the accompanying drawings.

### BRIEF DESCRIPTION OF THE DRAWINGS

FIG. 1 is a side elevational view of a bicycle being provided with an integrated anti-theft system and corresponding sub-assembly, according to a possible embodiment of the present invention, the bicycle being shown with its left and right crankarms (and associated pedals) disposed in a substantially vertical manner.

FIG. 2 is a side elevational view of the bicycle sub-assembly with integrated anti-theft system of FIG. 1, the bicycle sub-assembly with integrated anti-theft system being shown with its blocking assembly and associated at least one blocking mechanism in a first configuration (ex. in a “disengaged” configuration—i.e. away from the bore/space associated with the support frame for receiving the corresponding spindle of the bicycle) according to a possible embodiment of the present invention.

FIG. 3 is another side elevational view of what is shown in FIG. 2, the bicycle sub-assembly with integrated anti-theft system being now shown with its blocking assembly and corresponding at least one blocking mechanism in a second configuration (ex. in an “engaged” configuration—i.e. engaged with the bore/space associated with the support frame for receiving the corresponding spindle of the bicycle) according to a possible embodiment of the present invention.

FIG. 4 is a front elevational view of an anti-theft system, including blocking assembly and associated at least one blocking mechanism (ex. latch), according to a possible embodiment of the present invention, the at least one blocking mechanism (i.e. latch) being shown in a first configuration (ex. in a “disengaged” configuration).

FIG. 5 is a top view of what is shown in FIG. 4.

FIG. 6 is a side view of what is shown in FIG. 4.

FIG. 7 is another front elevational view of what is shown in FIG. 4, the at least one blocking mechanism (i.e. latch) being now shown in a second configuration (ex. in an “engaged” configuration), cooperating with a spindle and corresponding mounting component according to a possible embodiment of the present invention.

FIG. 8 is a top view of what is shown in FIG. 7.

FIG. 9 is a side view of what is shown in FIG. 7.

FIG. 10 is a top perspective view of an anti-theft system, including blocking assembly and associated at least one blocking mechanism (ex. male and female components provided on first and second coupling components of a coupling assembly) according to another possible embodiment of the present invention, the at least one blocking mechanism (i.e. male and female components, etc.) being shown cooperating with a spindle and being shown in a first configuration (ex. in a “disengaged” configuration) according to a possible embodiment of the anti-theft system.

FIG. 11 is a front elevational view of what is shown in FIG. 10.

FIG. 12 is a top view of what is shown in FIG. 10.

FIG. 13 is a side view of what is shown in FIG. 10.

FIG. 14 is another top perspective view of what is shown in FIG. 10, the at least one blocking mechanism (i.e. male and female components, etc.) being now shown in a second configuration (ex. in an “engaged” configuration) according to a possible embodiment of the anti-theft system.

FIG. 15 is a front elevational view of what is shown in FIG. 14.

FIG. 16 is a top view of what is shown in FIG. 14.

FIG. 17 is a side view of what is shown in FIG. 14.

FIG. 18 is a top perspective view of an anti-theft system, including blocking assembly and associated at least one blocking mechanism (ex. male and female components provided on first and second coupling components of a coupling assembly) according to another possible embodiment of the present invention, the at least one blocking mechanism (i.e. male and female components, etc.) being shown in an operative configuration (ex. in an “engaged” configuration) according to a possible embodiment of the anti-theft system.

FIG. 19 is a front elevational view of what is shown in FIG. 18.

FIG. 20 is a top view of what is shown in FIG. 18.

FIG. 21 is a side view of what is shown in FIG. 18.

FIG. 22 is a top perspective view of an anti-theft system, including blocking assembly and associated at least one blocking mechanism (ex. side-by-side bolts) according to another possible embodiment of the present invention, the at least one blocking mechanism (i.e. side-by-side bolts) being shown cooperating with a spindle and being shown in an operative configuration (ex. in an “engaged” configuration) according to a possible embodiment of the anti-theft system.

FIG. 23 is a front elevational view of what is shown in FIG. 22.

FIG. 24 is a top view of what is shown in FIG. 22.

FIG. 25 is a side view of what is shown in FIG. 22.

FIG. 26 is a top perspective view of an anti-theft system, including blocking assembly and associated at least one blocking mechanism (ex. circumferential bolts) according to another possible embodiment of the present invention, the at least one blocking mechanism (i.e. circumferential bolts) being shown cooperating with a spindle and being shown in an operative configuration (ex. in an “engaged” configuration) according to a possible embodiment of the anti-theft system.

FIG. 27 is a front elevational view of what is shown in FIG. 26.

FIG. 28 is a top view of what is shown in FIG. 26.

FIG. 29 is a top perspective view of an anti-theft system, including blocking assembly and associated at least one blocking mechanism (ex. ratchet mechanism with at least one pawl element and at least one abutment component) according to another possible embodiment of the present invention, the at least one blocking mechanism (i.e. ratchet mechanism, etc.) being shown cooperating with a spindle and being shown in an operative configuration (ex. in a unidirectionally “engaged” configuration) according to a possible embodiment of the anti-theft system.

FIG. 30 is a front elevational view of what is shown in FIG. 29.

FIG. 31 is a side view of what is shown in FIG. 29.

FIG. 32 is a top perspective view of an anti-theft system, including blocking assembly and associated at least one blocking mechanism (ex. unidirectional bearing with first and second bearing components) according to another possible embodiment of the present invention, the at least one blocking mechanism (i.e. unidirectional bearing, etc.) being shown cooperating with a spindle and being shown in a first configuration (ex. in a “disengaged” configuration) according to a possible embodiment of the anti-theft system.

FIG. 33 is a front elevational view of what is shown in FIG. 32.

FIG. 34 is a side view of what is shown in FIG. 32.

FIG. 35 is another top perspective view of what is shown in FIG. 32, the at least one blocking mechanism (i.e. unidirectional bearing, etc.) being now shown in a second configuration (ex. in an “engaged” configuration) according to a possible embodiment of the anti-theft system.

FIG. 36 is a front elevational view of what is shown in FIG. 35.

FIG. 37 is a top view of what is shown in FIG. 35.

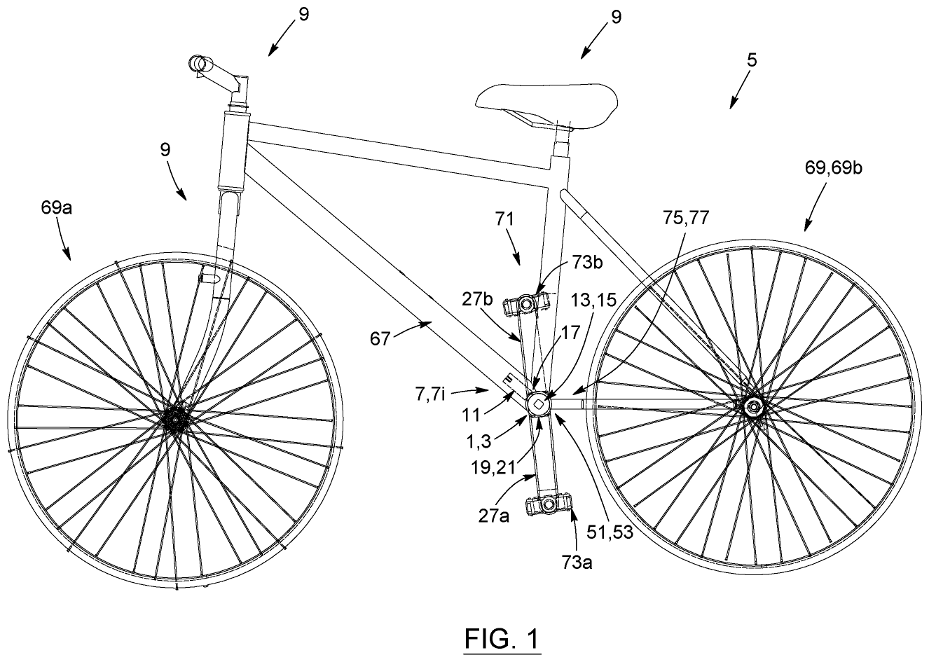

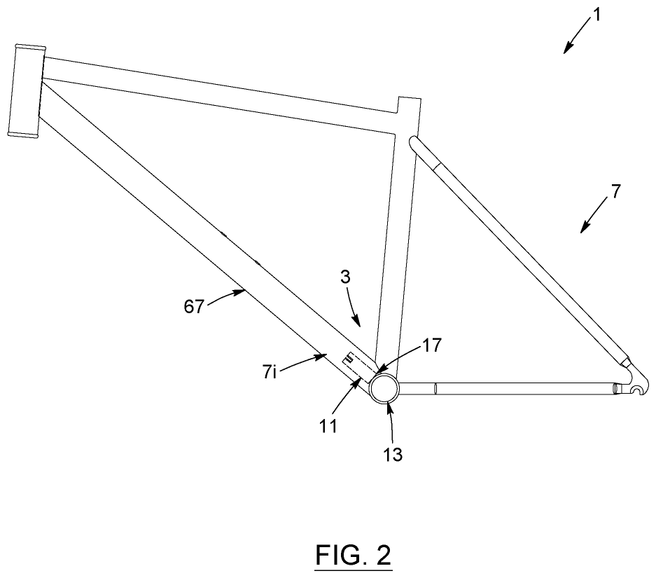

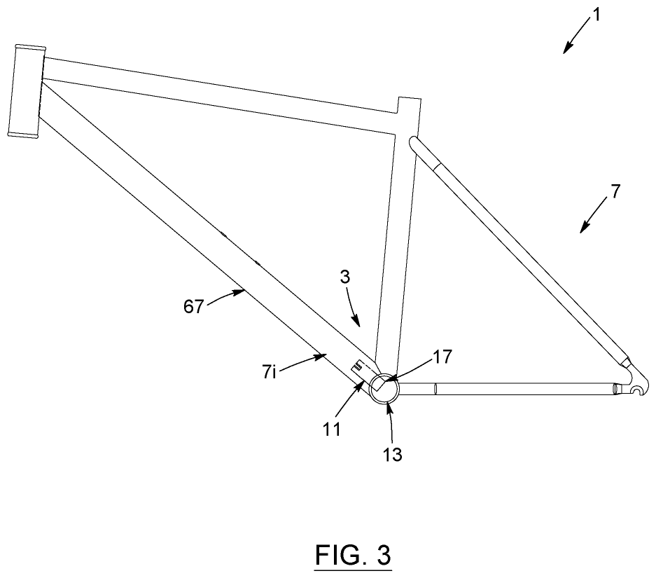

### DETAILED DESCRIPTION OF PREFERRED EMBODIMENTS OF THE INVENTION

In the following description, the same numerical references refer to similar elements. Furthermore, for sake of simplicity and clarity, namely so as to not unduly burden the figures with several reference numbers, only some figures have been provided with reference numbers, and components and features of the present invention illustrated in other figures can be easily inferred therefrom. The embodiments, geometrical configurations, materials mentioned and/or dimensions shown in the figures are preferred, for exemplification purposes only.

Moreover, although the present invention was primarily designed for use as an integrated anti-theft system for a wheeled vehicle such as a bicycle, for example, it may be used with other objects and/or in other types of applications, as apparent to a person skilled in the art. For this reason, expressions such as “integrated”, “anti-theft”, “system”, “wheeled”, “vehicle”, “bicycle”, etc., used herein should not be taken so as to limit the scope of the present invention and include all other kinds of objects and/or applications with which the present invention could be used and may be useful. For example, the present anti-theft system could also be used with and/or for various other types of wheeled vehicles, such as “motorcycles”, for instance, given that the same principle and/or system could be easily adapted to these types of vehicles, as well, as can be easily understood by a person skilled in the art.

Moreover, in the context of the present invention, the expressions “anti-theft”, “system”, “assembly”, “mechanism”, “device”, “apparatus”, “product”, “unit”, “equipment”, “tool”, “retrofit”, “hardware”, “method”, “instructions” and “kit”, as well as any other equivalent expressions and/or compound words thereof known in the art will be used interchangeably, as apparent to a person skilled in the art. This applies also for any other mutually equivalent expressions, such as, for example: a) “anti-theft”; “theft-avoiding”, “theft-reducing”, “theft-deterring”, “theft-delaying”, etc.; b) “vehicle”, “bicycle”, “tricycle”, “unicycle”, “motorcycle”, “bike”, etc.; c) “stroke”, “travel”, “range”, “motion”, etc.; d) “configuration”, “position”, “mode”, “state”, etc.; e) “passage”, “channel”, “conduit”, “path”, “orifice”, “hole”, “hollow”, “interior”, etc.; f) “blocking”, “stopping”, “halting”, “securing”, “restraining”, “affixing”, “holding”, “adjusting”, “preventing”, “delaying”, “deterring”, “hindering”, etc.; g) “latch”, “bolt”, “lock”, “pin”, “pawl”, “insert”, “peg”, “male component”, etc.; h) “recess”, “hole”, “bore”, “orifice”, “slot”, “cut-out”, “section”, “notch”, “female component”, etc.; as well as for any other mutually equivalent expressions, pertaining to the aforementioned expressions and/or to any other structural and/or functional aspects of the present invention, as also apparent to a person skilled in the art. Also, in the context of the present description, expressions such as “can”, “may”, “might”, “will”, “could”, “should”, “would”, etc., may also be used interchangeably, whenever appropriate, as also apparent to a person skilled in the art.

Furthermore, in the context of the present description, it will be considered that all elongated objects will have an implicit “longitudinal axis” or “centerline”, such as the longitudinal axis of shaft for example, or the centerline of a coiled spring, for example, and that expressions such as “connected” and “connectable”, or “mounted” and “mountable”, may be interchangeable, in that the present invention also relates to a kit with corresponding components for assembling a resulting fully-assembled and fully-operational anti-theft system (and/or a resulting fully-assembled and fully-operational assembly or sub-assembly (ex. frame and/or any other associated constituting components, etc.) and/or a resulting fully-assembled and fully-operational vehicle (ex. bicycle, etc.) provided with the same, etc.).

Moreover, components of the present system(s) and/or steps of the method(s) described herein could be modified, simplified, altered, omitted and/or interchanged, without departing from the scope of the present invention, depending on the particular applications which the present invention is intended for, and the desired end results, as briefly exemplified herein and as also apparent to a person skilled in the art.

In addition, although the preferred embodiments of the present invention as illustrated in the accompanying drawings comprise various components, and although the preferred embodiments of the present anti-theft system and corresponding portion(s)/part(s)/component(s) as shown consist of certain geometrical configurations, as explained and illustrated herein, not all of these components and geometries are essential to the invention and thus should not be taken in their restrictive sense, i.e. should not be taken so as to limit the scope of the present invention. It is to be understood, as also apparent to a person skilled in the art, that other suitable components and cooperation thereinbetween, as well as other suitable geometrical configurations may be used for the present anti-theft system and corresponding portion(s)/part(s)/component(s) according to the present invention, as will be briefly explained herein and as can be easily inferred herefrom by a person skilled in the art, without departing from the scope of the present invention.

Broadly described, and as better exemplified in the accompanying drawings, the present invention relates to an anti-theft system to be integrated into a corresponding assembly and/or sub-assembly (ex. frame, etc.) of a wheeled vehicle, such as a bicycle, for example, and intended to prevent, or at the very least, reduce an occurrence of unauthorized use thereof (ex. “theft”, etc.), and to do so in a quicker, simpler, more precise, more efficient, more economical, more reliable, more adjustable, more versatile, more adaptable, more durable, more environmentally conscientious, more functional, more sustainable, more desirable, and/or improved manner, than what is possible with other conventional systems.

### LIST OF NUMERICAL REFERENCES FOR SOME OF THE CORRESPONDING POSSIBLE COMPONENTS ILLUSTRATED IN THE ACCOMPANYING DRAWINGS

1. sub-assembly (of “bicycle” and/or any other related “vehicle”)
3. anti-theft system
5. bicycle (and/or any other related “vehicle”)
7. support frame
7i. hollow portion (of support frame)
9. constituting component
11. blocking assembly
13. bore
15. spindle
15i. hollow interior (of spindle)
17. blocking mechanism (of blocking assembly)
19. authentication mechanism (of blocking assembly)
21. activation mechanism (of blocking assembly)
23. latch
25. recess (for receiving latch)
27. crankarm
27a. left crankarm
27b. right crankarm
29. mounting component (for recess operatively provided on spindle)
31. rounded edge
33. male component (of blocking mechanism)
35. female component (of blocking mechanism)
37. biasing assembly (of blocking mechanism)
39. spring (of biasing assembly)
41. coupling assembly (of blocking mechanism)
43. first coupling component (of coupling assembly)
45. second coupling component (of coupling assembly)
47. spline
49. bolt
51. hole (for receiving bolt)
53. affixing component (for hole operatively provided on frame)
55. slot (associated with bolt)
57. ratchet mechanism (of blocking mechanism)
59. pawl element (of ratchet mechanism)
61. abutment component (of ratchet mechanism)
63. first bearing component (of unidirectional bearing)
65. second bearing component (of unidirectional bearing)
67. tube (of support frame)
69. wheel (ex. driven wheel)
69. front wheel
69b. rear wheel
71. pedal assembly
73. pedal
73a. left pedal
73b. right pedal
75. transmission assembly
77. motorized assembly
D. direction of rotation (of ratchet mechanism)

As will be explained in great detail hereinbelow, the present system, according to a possible intended use, enables to block the rotation of the bicycle spindle and pedals, to prevent a case of unauthorized use. Given that the general motivation behind bicycle theft is usually the reselling and/or using the bike, the present system prevents, or at the very least greatly hinders, any theft attempt because it increases the complexity to remove/destroy the system since it is not easily accessible.

As will be better appreciated from the follow description, the present system thus has the potential of dramatically reducing bike theft rate on a very large scale and propelling bikes forward as an essential clean and active mode of transportation.

Such innovation can also change the way we design and interact with densely populated cities, in that, the present system is not only meant for private-owned bikes only, but also, public and private bike fleets as well. Thus, the present system could also alleviate the need for bike-sharing fleets to have expensive stations and infrastructure around the city. Namely, their bikes could potentially be activated and deactivated by locking and unlocking the pedals' movement from within the bike using the present system and “IoT” (i.e. “internet of things”) technologies. This would free up public spaces from stations and allow bike distribution around the city based on offer and demand, instead of having to rely on station availability. Another potential advantage could be the increase in the number of bikes since it will be no longer limited by the number of stations.

As can be easily understood when referring to the following description and the accompanying drawings, the present anti-theft system (1) may come in the form of an anti-theft system (1) including one and/or several of the following possible components and features (and/or different possible combination(s) and/or permutation(s) thereof):

Indeed, it is worth mentioning that the present anti-theft system (1) can come, and thus, can be commercialized in various shapes and forms, ranging from the anti-theft system (1) itself (and/or a kit with corresponding components and/or instructions for assembling and/or installing the same), to a resulting fully-assembled and fully-operational assembly or sub-assembly (ex. frame and/or any other associated constituting components, hardware, etc.), and/or a resulting fully-assembled and fully-operational vehicle (ex. bicycle, etc.) provided with the same, etc.

Bicycles are well known in the art, and thus, in the context of the present description there is little/no need to explain in great details the different possible components and features of bicycles, and how they operate and/or cooperate with one another. Some examples of possible constituting component(s) (9) of a bicycle (5) are simply presented below, in alphabetical order, based on a list taken from Wikipedia™ at the following link: https://en.wikipedia.orq/wiki/List of bicycle parts):

“Bicycle parts
For other cycling related terms (besides parts) see Glossary of cycling.
List of bicycle parts by alphabetic order:
Axle: as in the generic definition, a rod that serves to attach a wheel to a bicycle and provides support for bearings on which the wheel rotates. Also sometimes used to describe suspension components, for example a swing arm pivot axle
Bar ends: extensions at the end of straight handlebars to allow for multiple hand positions
Bar plugs or end caps: plugs for the ends of handlebars
Basket: cargo carrier
Bearing: a device that facilitates rotation by reducing friction
Bell: an audible device for warning pedestrians and other cyclists
Belt-drive: alternative to chain-drive
Bicycle brake cable: see Cable
Bottle cage: a holder for a water bottle
Bottom bracket: The bearing system that the pedals (and cranks) rotate around. Contains a spindle to which the crankset is attached and the bearings themselves. There is a bearing surface on the spindle, and on each of the cups that thread into the frame. The bottom bracket may be overhaulable (an adjustable bottom bracket) or not overhaulable (a cartridge bottom bracket). The bottom bracket fits inside the bottom bracket shell, which is part of the bicycle frame
Brake: devices used to stop or slow down a bicycle. Rim brakes and disc brakes are operated by brake levers, which are mounted on the handlebars. Band brake is an alternative to rim brakes but can only be installed at the rear wheel. Coaster brakes are operated by pedaling backward
Brake lever: a lever for actuating a bicycle brake
Brake shifter or colloquially, brifter (see also Shimano Total Integration, Campagnolo ErgoPower and SRAM Double Tap): combined shifter and brake lever control
Braze-on: a fitting protruding from a frame to provide attachment, typically for cable housings or tire pumps and similar accessories
Cable guide: a fitting below the bottom bracket which guides a piece of bare inner bowden cable around a corner
Cable: a metal cable enclosed in part by a metal and plastic housing that is used to connect a control, such as a brake or shifting lever, to the device it activates
Cartridge bearing: a type of bearing that is not user-serviceable, but must be replaced as a unit
Cassette: a group of stacked sprockets on the rear wheel of a bicycle with a rear derailleur
Coaster brake or backpedal brake
Chain: a system of interlinking pins, plates and rollers that transmits power from the front sprocket(s) to the rear sprocket(s)
Chainguard: Gear case cover for the entire chain either totally encasing (sometimes containing oil) or ‘incomplete’. Either way, designed to keep clothing from fouling the chain. See also Skirtguard, Bashquard.
Chainrinq: (one of the) front gear(s), attached to a crank
Chainset: see Crankset
Chainstav: a pair of tubes on a bicycle frame that runs from the bottom bracket to the rear fork ends
Chain tensioner a device to maintain proper chain tension
Chaintuq: a device to aid in setting the proper chain tension
Cluster a bicycle cosset, either a freewheel, or cassette
Cogset: the set of rear sprockets that attaches to the hub on the rear wheel
Cone: holds bearings in place, pressed against the cup
Cotter: pin for attaching cottered cranks
Coupler: to connect tubing together
Crankset or chainset: composed of cranks and at least one chainring
Cup: receives ball bearings which roll along its inner surface; integrated on most conventional hubs or can be pressed into older bottom bracket shells. See also Cone
Cyclocomputer: an electronic accessory that measures and displays instantaneous and cumulative speed and distance. Often provides other measurements such as heart rate
Derailleur hanger: a piece on the rear dropout that the derailleur attaches to.
Derailleur: an assembly of levers, usually cable actuated, that moves the chain between sprockets on a cassette or chainring assembly
Down tube: tube on the bicycle frame that runs from the head tube to the bottom bracket
Dropout: a bicycle rear fork end that allows the rear wheel to be removed without first derailing the chain. The term dropout is often incorrectly used to refer to any fork end, but not all fork ends are dropouts
Dustcap: any cap serving to keep dirt and contamination out of an assembly. Common over crank bolts, often plastic
Dynamo: bicycle lighting component, also known as generator
Eyelet:
   1) attachment point on frame, fork, or dropout for fenders, racks, etc.
   2) a hole through which a spoke nipple passes through the rim so it may attach to a spoke
Electronic Gear-Shifting System: not simply a type of shifter or a type of derailleur, a complete system with switches instead of levers, wires instead of Bowden cables, and motor-driven derailleurs that must all work together
Fairing: a full or partial covering for a bicycle to reduce aerodynamic drag or to protect the rider from the elements
Fender or mudguard: curved pieces of metal or plastic above the tires which catch and redirect road spray thrown up by the tires, allowing the rider to remain relatively clean. May come in pairs
Ferrule: a metal or plastic sleeve used to terminate the end of a cable housing
Fork: a mechanical assembly that integrates a bicycle's frame to its front wheel and handlebars, allowing steering by virtue of its steerer tube
Fork end: paired slots on a fork or frame at which the axle of the wheel is attached. See also Dropout
Frame: the mechanical core of a bicycle, the frame provides points of attachment for the various components that make up the machine. The term is variously construed, and can refer to the base section, always including the bottom bracket, or to base frame, fork, and suspension components such as a shock absorber
Freehub: a ratcheting assembly onto which a cog or cassette is mounted that allows the bicycle to coast without the pedals turning
Freewheel: a ratcheting assembly that incorporates one or more cogs and allows the bicycle to coast without the pedals turning
Gusset: plates added to the outsides of frame tubes to strengthen joints. These are more commonly seen on BMX and mountain bikes
Hanger: part of frame or an attachment to the frame to which the derailleur is attached (see Derailleur hanger)
Handlebar: a lever attached, usually using an intermediary stem, to the steerer tube of the fork. Allows steering and provides a point of attachment for controls and accessories
Handlebar plug: see Bar plugs
Handlebar tape: a tape wound around dropped handlebars so as to provide padding and grip, usually cork or cloth, sometimes foam rubber
Head badge: manufacturer's or brand logo affixed to the head tube
Head tube: the tube of a bicycle frame that contains the headset
Headset: the bearings that form the interface between the frame and fork steerer tube
Hood: the rubber brake lever covering on bikes with drop style handle bars
Hub: the core of a wheel; contains bearings and, in a traditional wheel, has drilled flanges for attachment of spokes
Hub dynamo: a generator inside one of the hubs for powering lights or other accessories
Hub gear: a gearbox mounted inside the hub, 3-speed is common, 5, 7 are available (“Sturmey-Archer”) and Rohloff make a 14-speed hub. Cable operated by one or two cables
Indicator: a turn signal
Inner tube: a bladder that contains air to inflate a tire. Has a Schrader, “Woods”/“Dunlop” or Presta valve for inflation and deflation
Jockey wheel: one of two small sprockets of the rear derailleur that guides the chain
Kickstand: a folding attachment used for assisting a bicycle to stand up on its own. Usually mounts to frame near bottom bracket, sometimes near rear dropouts
“Lawyer lips”: also called a “lawyer tab”, a retention device on the dropouts of the front fork to prevent inadvertent loss of the front wheel in the case it is not properly secured
Locknut: a nut designed not to loosen due to vibration
Lockring: a ring, usually metal, of varying design, that serves to retain a component in place
Lug: a metal connector used to align frame components where they join each other
Luggage carrier: any accessory equipment designed to carry tools, gear or cargo
Master link: a bicycle chain accessory that allows convenient removal and reconnection of an installed bicycle chain without the need for a chain tool
Nipple: a specialized nut that most commonly attaches a spoke to a wheel rim. In some systems, it provides attachment to the hub
Pannier: cloth zippered storage bags that mount to sides of luggage racks. Pronounced pan-ear, or pan-yer (an old English word, which is derived from an old French word)
Pedal: mechanical interface between foot and crank arm. There are two general types; one secures the foot with a mechanical clamp or cage and the other has no connection to lock the foot to the pedal.
Peg: short metal tube, about 6 inches (15 cm) long and 2 inches (5.1 cm) fastened to one or both ends of the wheel axles to either enable the rider perform certain tricks or provide a place for extra riders to stand or rest
Portage strap: a strap (usually made of leather) attached to the inside of the bike frame, designed to make carrying the bike over one's shoulder easier
Quick release: a skewer with a lever on one end that loosens when the lever is flipped. Used for releasing wheels and seat posts
Rack: a rack that attaches behind the seat, usually with stays to the rear dropouts, that serves as a general carrier
Reflector reflects light to make bicycle evident when the illuminated by headlights of other vehicles. Usually required by law but held in disdain by many cyclists
Removable training wheels: used for assisting balance. Comes in pair. Useful for first time bicyclists
Rim: that part of a wheel to which the tire is attached and often forms part of the braking mechanism
Rotor:
   1) the disc component of a disc brake.
   2) another name for a detangler—a device that allows the handlebars and fork to revolve indefinitely without tangling the rear brake cable.
Safety levers: extension levers, and interrupt brake levers. Used to apply brakes in order for the bicycle to slow down or suddenly stop
Saddle or Seat: what a bicyclist sits on
Seat rails: a metal framework over which saddle covering is stretched. The seat post attaches to the seat rails by means of a clamp
Seat lug: a frame lug on the top of the seat tube serving as a point of attachment for a clamp to secure the seat post
Seat tube: the roughly vertical tube in a bicycle frame running from the seat to the bottom bracket
Seat bag: a small storage accessory hung from the back of a seat
Seatpost: a post that the seat is mounted to. It slides into the frame's seat tube and is used to adjust ride height depending how far into the seat tube it is inserted
Seatstay: frame components, small diameter tubes running from top of seat tube to rear dropouts
Shaft-drive: alternate to chain-drive
Shifter: gear shifting control
Shock absorber for bicycles with suspensions, a device that limits the rate at which suspension rebounds after absorbing an impact
Side view mirror: aids in looking at the sides prior to moving slowly or turning to the left or to the right
Skirt guard or coatguard: a device fitted over the rear wheel of a bicycle to prevent a long skirt, coat or other trailing clothes or luggage from catching in the wheel, or in the gap between the rim and the brakes
Spindle: an axle around which a pedal rotates; threaded at one end to screw into crank arms
Spoke: connects wheel rim to hub. Usually wire with one end swaged to form a head and one threaded end. A typical wheel has 36 spokes
Speakers: loudspeakers specifically made for bicycles and/or strollers for cyclists and pedestrians with children to listen music or answer phone calls on their mobile devices when bicycling or transporting children. Both wireless and wired speakers are available to mount on their handlebars or frames. Even though speakers specifically made for bicycles are available to purchase, but depending on the sizes and shapes and the cyclists' ingenuities, any speakers can be strapped on to them typically by using silicone strippings. These speakers meant to eliminate the risks of using headphones such as obliviousness of incoming cars and other warnings, and continuous playing of music from them would also alert other cyclists and pedestrians nearby
Sprocket or cog: wheel with teeth that meshes with the chain; one of the wheels in the cosset or crankset
Steerer tube: a tube on top of a fork that is inserted through frame and serves as an axle by means of which bicycle can be steered
Stem: a bracket used to attach handlebars to steerer tube of fork. Usually secured by pinch bolts
Tire: as in common usage. Usually pneumatic. A tubular tire is glued to the wheel rim; most tires use tubes, but tubeless tires and rims are increasingly common
Toe clips: a metal or plastic cage attached to a pedal. Usually has an adjustment strap. Secures foot to pedal for increased control and more effective transfer of power from foot to drive chain
Top tube: frame member leading from head tube to seat tube
Valve stem or simply valve: port for adding or releasing air from the inner tube. Two types are commonly used: Presta and Schrader. A third type, the Woods/Dunlop valve, can still be found in Europe and Asia.
Wheel: as in common usage. Traditionally and most commonly spoked
Wingnut: for attaching wheels before the development of the quick release skewer”.

According to one possible aspect of the present invention, and as can be easily understood when referring to the accompanying drawings, there is provided a bicycle sub-assembly (1) with integrated anti-theft system (3) for use (ex. for mounting, assembling, manufacturing, retrofitting, upgrading, etc.) with a corresponding bicycle (5), for providing said bicycle (5) with an integrated anti-theft capability. The bicycle sub-assembly (1) may comprise a support frame (7) for operatively receiving at least one corresponding constituting component (9) of the bicycle, and may also comprise a blocking assembly (11) being operatively mountable onto the support frame (7), adjacent to a corresponding bore (13) associated with the support frame (7) for receiving a corresponding spindle (15) of the bicycle (5). It is worth mentioning that the bore (13) may be provided directly on the support frame (7), and/or alternatively, on another separate component meant to be operatively mounted onto the support frame (7), so long as a corresponding bore (13) is provided, and is associated with the support frame (7), once assembled, for receiving the spindle (15), as can be easily understood by a person skilled in the art. According to the present anti-theft system (3), the blocking assembly (11) has at least one blocking mechanism (17) being operatively cooperable with said spindle (15), the blocking assembly (11) being selectively operable by an authorized user of the bicycle (5) between a first configuration where the at least one blocking mechanism (17) allows the spindle (15) to rotate within the corresponding bore (13) associated with the support frame (7) along an intended mode of the bicycle (5), and a second configuration where the at least one blocking mechanism (17) operatively interacts with the spindle (15) to prevent said spindle (15) from rotating within the corresponding bore (13) associated with the support frame (7) along the aforementioned intended mode of the bicycle (5), so as to impede an unauthorized use of the bicycle (5).

According to a possible embodiment, the blocking assembly (11) is provided with an authentication mechanism (19) for recognizing the authorized user of the bicycle (5) and for allowing said authorized user to operate the bicycle (5) and the corresponding blocking assembly (11) thereof. The authentication mechanism (19) may come in various shapes and forms, but as way of example(s), may be an authentication mechanism (19) selected from the group consisting of a mechanical authentication mechanism (19), an electrical authentication mechanism (19), an electromechanical authentication mechanism (19), an electronic authentication mechanism (19), a computer authentication mechanism (19), a software authentication mechanism (19), a biometric authentication mechanism (19), a remote internet-based authentication mechanism (19), and/or a combination of said authentication mechanisms (19), as can be easily understood by a person skilled in the art.

It is worth mentioning that the authentication mechanism (19) can be any mechanism and/or manner for recognizing the authorized user of the bicycle (5) and for allowing said authorized user to operate the bicycle (5) and the corresponding blocking assembly (11) thereof. For example, the authentication mechanism (19) can be any of the above-mentioned authentication mechanisms (19) for recognizing the authorized user, either directly, and/or indirectly, via a recognition of some other relevant parameter (ex. access code, access key, various others forms of identification and/or validation, etc.) associated with the authorized user (and/or with authorized personnel that can and/or should have access to the bicycle (5) as well, such as the owner of the bicycle (5), for example, when the authorized user is not the actual owner of the bicycle (5), but rather a “renter” and/or an “allowed user”, etc.).

Similarly, the blocking assembly (11) may be provided with an activation mechanism (21) to allow the authorized user of the bicycle to selectively operate the blocking assembly (11) between the first and second configurations. The activation mechanism (21) may come in various shapes and forms, but as way of example(s), may be an activation mechanism (21) selected from the group consisting of a mechanical activation mechanism (21), an electrical activation mechanism (21), an electromechanical activation mechanism (21), an electronic activating mechanism, a computer activation mechanism (21), a software activation mechanism (21), a biometric activation mechanism (21), a remote internet-based activation mechanism (21), and/or a combination of said activation mechanisms (21), as can be easily understood by a person skilled in the art.

Similarly to the above-discussed, it is worth mentioning that the activation mechanism (21) can be any mechanism and/or manner for allowing the authorized user of the bicycle to selectively operate the blocking assembly (11) between the first and second configurations. For example, the activation mechanism (21) can be any of the above-mentioned activation mechanisms (21) for allowing to operate the blocking assembly (11), either directly, and/or indirectly, via a corresponding activation of a component (ex. a button, a lever, a switch, etc.), and/or via at least one corresponding action and/or combination of actions (of the anti-theft system (3) itself, and/or of any other component(s) of the bicycle (5), etc.).

It worth mentioning also that the present authentication mechanism (19) and activation mechanism (21) do not need to be “separate” mechanisms, in that, the present anti-theft system (3) also contemplates a mechanism that could do “both at the same time”, such as a “authentication/activation mechanism” (19,21), as can be easily understood by a person skilled in the art. For instance, and in a very simplified mechanical embodiment, given for exemplification purposes only, such a combined mechanism (19,21) could simply consist of a physical “key”, meant to be inserted into a corresponding “slot” of the anti-theft system (3), where insertion of the key into the slot enables to “recognize” the user, and turning of the key enables to “operate” the anti-theft system (3) between first and second configurations, for example. Obviously, the different embodiments of the authentication mechanism (19), activation mechanism (21), and/or a combination versions of both, that can be used for the present anti-theft system (3) are multiple, depending on the particular applications which the present anti-theft system (3) is intended for, and the desired end results, as well as the desired levels of complexity and security being sought out, as also apparent to a person skilled in the art. It is worth mentioning also that the authentication mechanism (19), the activation mechanism (21), and/or a combined version thereof, can be located directly on the anti-theft system (3) itself, in proximity thereof, and/or on any other component(s) of the bicycle (5), so long as there is an appropriate connection (ex. mechanical, electrical, wireless, etc.) and/or interaction between these mechanisms (19,21) and the anti-theft system (3), as can be easily understood by a person skilled in the art.

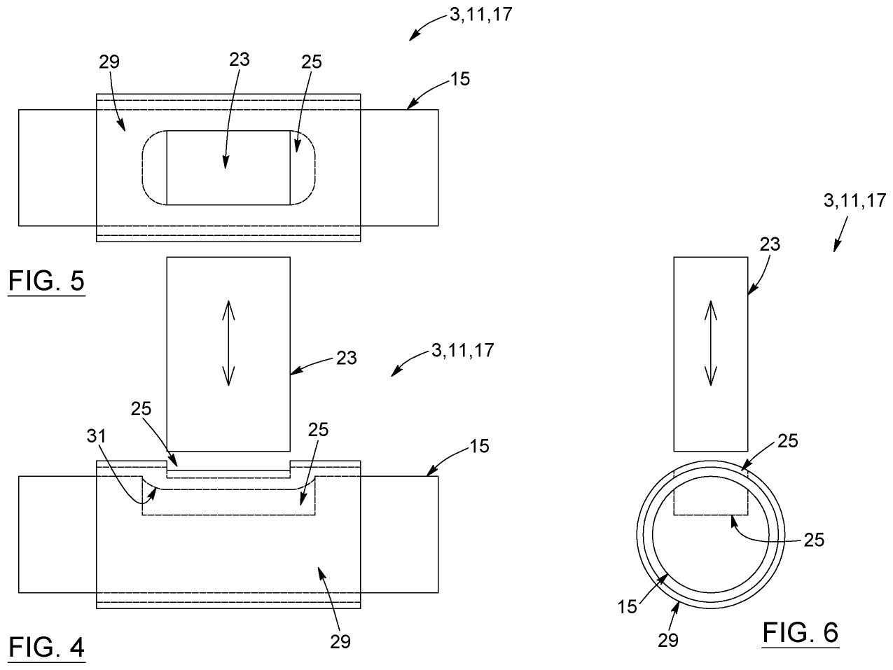

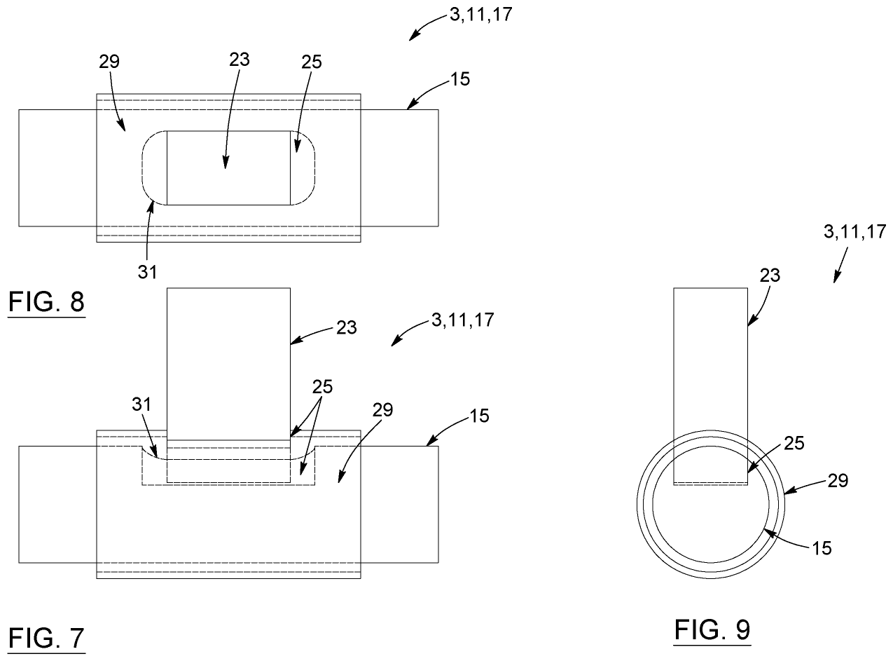

As can be easily understood when referring to FIGS. 4-9, and according to a possible embodiment of the present anti-theft system (3), the at least one blocking mechanism (17) of the blocking assembly (11) includes a latch (23), and the anti-theft system (3) can be designed so that in the first configuration of the blocking assembly (11), the latch (23) is positioned away from the spindle (15), and in the second configuration of the blocking assembly (11), the latch (23) is removably inserted into a corresponding recess (25) associated with the spindle (15), for preventing the spindle (15) from rotating with respect to the corresponding bore (13) associated with the support frame (7).

The latch (23) and the corresponding recess (25) associated with the spindle (15) can be positioned, shaped and sized with respect to each other so as to prevent the spindle (15) from being longitudinally displaced and removed from its corresponding bore (13) associated with the support frame (7), thereby further providing the bicycle (5) (and/or corresponding sub-assembly (3)), with additional anti-theft capability.

Optionally also, the latch (23) and the corresponding recess (25) associated with the spindle (15) can be positioned, shaped and sized with respect to each other so that the latch (23) is removably insertable into said recess (25) when left and right crankarms (27a,27b) of the bicycle (5) are disposed in a substantially vertical manner, thereby making it harder (or even “impossible”) for an unauthorized user of the bicycle (5) to use a torque/moment of own weight on the pedal(s) of the bicycle (5), for example, to try to overcome or break the blocking action provided by the latch (23), thereby further providing the bicycle (5) (and/or corresponding sub-assembly (3)), with an additional anti-theft protection.

As can be easily understood, the recess (25) associated with the spindle (15) may come in various shapes and forms. For example, the recess (25) associated with the spindle (15) may be a cut-out section operatively provided about the spindle (15). The recess (25) associated with the spindle (15) could have a circular profile or an oblong profile, for example. It can be easily understood also that the recess (25) associated with the spindle (15) may be positioned, shaped and sized directly onto the spindle (15) itself, and/or the recess (25) associated with the spindle (15) may be positioned, shaped and sized onto a corresponding mounting component (29) being operatively mountable about the spindle (15).

Similarly, the latch (23) may come in various shapes and forms. For example, the latch (23) may have a substantially circular cross-sectional profile, a substantially oblong cross-sectional profile, a substantially rectangular cross-sectional profile, a substantially square cross-sectional profile, and/or any other appropriate cross-sectional profile.

Preferably, the recess (25) associated with the spindle (15) has a cross-sectional profile being greater than that of the latch (23) for receiving said latch (23) into the recess (25), and the recess (25) associated with the spindle (15) has a cross-sectional profile being complementary in shape to the cross-sectional profile of the latch (23). Optionally, at least one (and/or both) of the cross-sectional profile of the recess (25) associated with the spindle (15) and the cross-sectional profile of the latch (23) has rounded edges (31) for allowing a certain tolerance during an insertion of the latch (23) into the recess (25) associated with the spindle (15) when the blocking assembly (11) is operated into the second configuration.

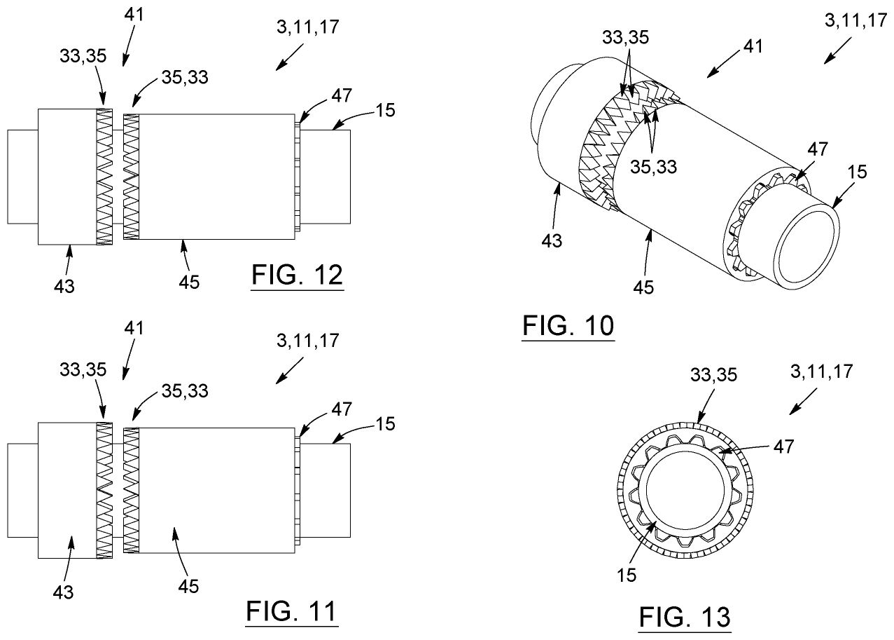

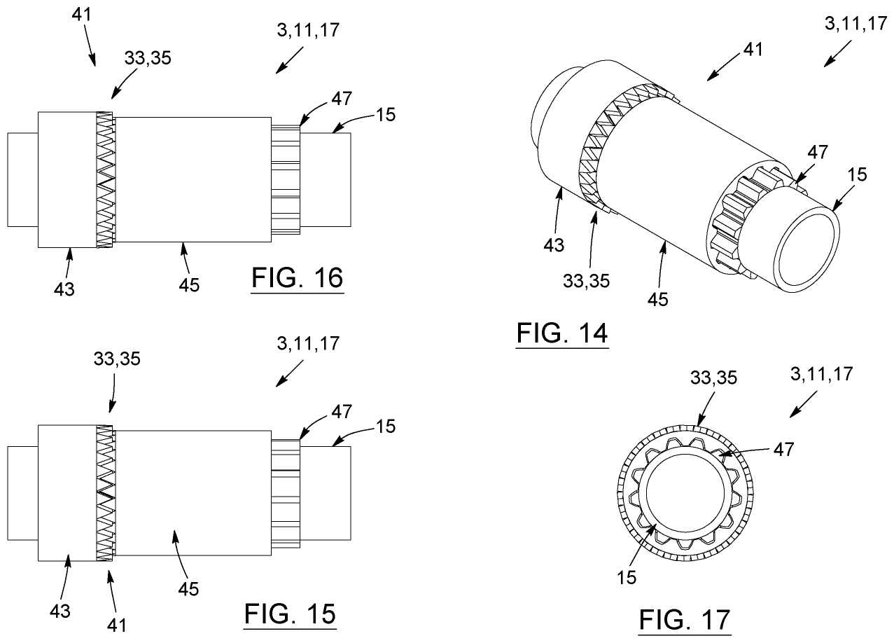

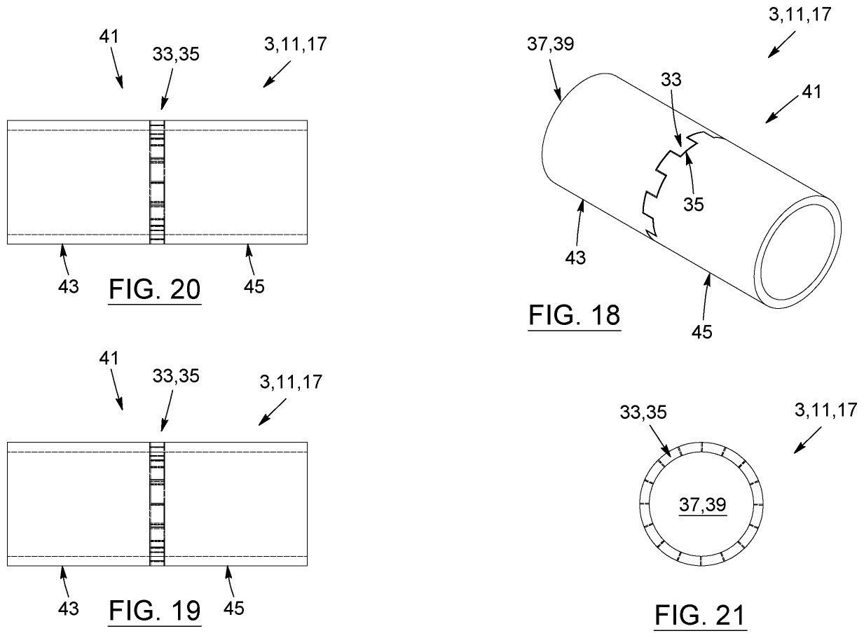

As can be easily understood when referring to FIGS. 10-21, and according to another possible embodiment of the present anti-theft system (3), the at least one blocking mechanism (17) of the blocking assembly (11) includes male and female components (33,35), one of said male and female components (33,35) being operatively provided about the spindle (15), and another one of said male and female components (33,35) being operatively provided about the corresponding bore (13) associated with the support frame (7), and the anti-theft system (3) can be designed so that in the first configuration of the blocking assembly (11), the male and female components (33,35) are disengaged from each other, thereby allowing the spindle (15) to rotate within the corresponding bore (13) associated with the support frame (7) along its intended mode, and in the second configuration of the blocking assembly (11), the male and female components (33,35) are engaged with one another, thereby preventing the spindle (15) from rotating with respect to the corresponding bore (13) associated with the support frame (7).

The at least one blocking mechanism (17) of the blocking assembly (11) can include a biasing assembly (37) for biasing the male and female components (33,35) towards one another, for an increased engagement between said male and female components (33,35), when the blocking assembly (11) is operated in the second configuration, thereby further providing the bicycle (5) (and/or corresponding sub-assembly (3)), with an additional anti-theft protection. The biasing assembly (37) may include at least one spring (39) operatively acting against at least one of the male and female components (33,35) for biasing said male and female components (33,35) towards one another, when the blocking assembly (11) is operated in the second configuration. It is worth mentioning that other appropriate biasing assemblies (37) are also contemplated for the present system (3), as apparent to a person skilled in the art.

As can be easily understood from the figures, the male and female components (33,35) may be provided onto a coupling assembly (41) having first and second coupling components (43,45), a first coupling component (43) being operatively mounted about the spindle (15), and the second coupling component (45) being operatively mounted about the corresponding bore (13) associated with the support frame (7).

According to a possible embodiment, the first coupling component (43) of the coupling assembly (41) may rotate with the spindle (15), whereas the second coupling component (45) may remain substantially fixed with respect to the corresponding bore (13) associated with the support frame (7), depending on the particular applications which the present anti-theft system (3) is intended for, and the desired end results, as apparent to a person skilled in the art.

As can be easily understood, in its simplest form, the first coupling component (43) may include at least one of the male and female components (33,35), and the second coupling component (45) may include at least the other one of the male and female components (33,35), but according to the embodiment illustrated in the figures, the first coupling component (43) includes at first plurality of male and female components (33,35), and the second coupling component (45) includes a second plurality of male and female components (33,35), such that, in the first configuration of the blocking assembly (11), the male and female components (33,35) of the first plurality of male and female components (33,35) are disengaged from the male and female components (33,35) of the second plurality of male and female components (33,35), thereby allowing the spindle (15) to rotate within the corresponding bore (13) associated with the support frame (7) along its intended mode, and in the second configuration of the blocking assembly (11), the male and female components (33,35) of the first plurality of male and female components (33,35) are engaged with associated components of the second plurality of male and female components (33,35), thereby preventing the spindle (15) from rotating with respect to the corresponding bore (13) associated with the support frame (7) along its intended mode.

As can be easily understood also, the biasing assembly (37) may be operatively acting against at least one of the first and second coupling components (43,45) for biasing said first and second coupling components (43,45) towards one another, when the blocking assembly (11) is operated in the second configuration, thereby further providing the bicycle (5) (and/or corresponding sub-assembly (3)), with an additional anti-theft protection.

The male and female components (33,35) may come in various shapes and forms. For example, the male and female components (33,35) may have a substantially triangular profile, a substantially rectangular profile, a substantially square profile, and/or any other appropriate cross-sectional profile. Optionally, the male and female components (33,35) can cooperate with corresponding splines (47) of the blocking assembly (11) and/or any other appropriate means for ensuring an operation between first and second configurations of the blocking assembly (11) (i.e. between “engaged” and “disengaged” configurations of the anti-theft system (3)). Indeed, the present anti-theft system (3) contemplates any other assembly allowing a proper “relative motion” (ex. movement, displacement, positioning, repositioning, angular adjustment, alignment, etc.) between different parts of the anti-theft system (3) for allowing an proper operation of its blocking assembly (11) and its associated at least one blocking mechanism (17) between the first and second configurations, irrespectively of the nature of the at least one blocking mechanism (17) being used, given that the at least one blocking mechanism (17) can come in various shapes and forms, as described and/or alluded to herein, as well as exemplified in the accompanying drawings, and as apparent to a person skilled in the art.

Optionally also, the male and female components (33,35) are positioned, shaped and sized with respect to each other so as to engageable with one another when left and right crankarms (27a,27b) of the bicycle (5) are disposed in a substantially vertical manner, thereby making it harder (or even “impossible”) for an unauthorized user of the bicycle (5) to use a torque/moment of own weight on the pedal(s) of the bicycle (5), for example, to try to overcome or break the blocking action provided by the latch (23), thereby further providing the bicycle (5) (and/or corresponding sub-assembly (3)), with an additional anti-theft protection.

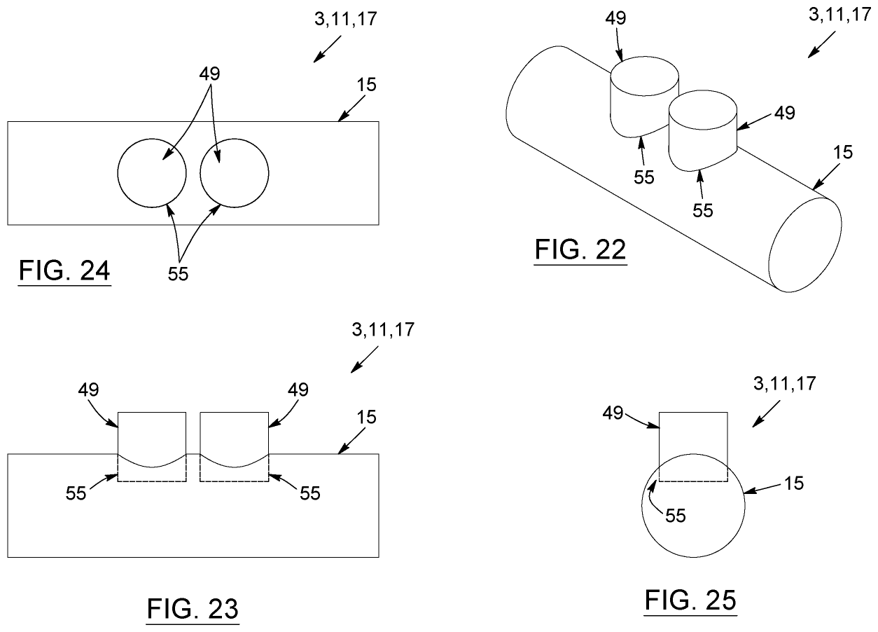

As can be easily understood when referring to FIGS. 22-28, and according to another possible embodiment of the present anti-theft system (3), the at least one blocking mechanism (17) of the blocking assembly (11) includes at least one bolt (49) positioned inside the spindle (15), and operable between retracted and extended positions, and the anti-theft system (3) can be designed so that in the first configuration of the blocking assembly (11), the at least one bolt (49) is retracted within the spindle (15), and in the second configuration of the blocking assembly (11), the at least one bolt (49) is extended outwardly from the spindle (15) and removably insertable into a corresponding hole (51) associated with the support frame (7), for preventing the spindle (15) from rotating with respect to the corresponding bore (13) associated with the support frame (7).

The at least one bolt (49) and the corresponding hole (51) associated with the support frame (7) can be positioned, shaped and sized with respect to each other to prevent the spindle (15) from being longitudinally displaced and removed from its corresponding bore (13) associated with the support frame (7), thereby further providing the bicycle (5) (and/or corresponding sub-assembly (3)), with additional anti-theft capability.

Optionally also, the at least one bolt (49) and the corresponding hole (51) associated with the support frame (7) cane be positioned, shaped and sized with respect to each other so that the at least one bolt (49) is removably insertable into said hole (51) of the support frame (7) when left and right crankarms (27a,27b) of the bicycle (5) are disposed in a substantially vertical manner, thereby making it harder (or even “impossible”) for an unauthorized user of the bicycle (5) to use a torque/moment of own weight on the pedal(s) of the bicycle (5), for example, to try to overcome or break the blocking action provided by the at least one bolt (49), thereby further providing the bicycle (5) (and/or corresponding sub-assembly (3)), with an additional anti-theft protection.

According to one possible embodiment, the corresponding hole (51) associated with the support frame (7) can be positioned, shaped and sized directly onto the support frame (7) itself. Alternatively, and/or in a complementary manner, the corresponding hole (51) associated with the support frame (7) may be positioned, shaped and sized onto a corresponding affixing component (53) being operatively mountable about the support frame (7), depending on the particular applications which the present anti-theft system (3) is intended for, and the desired end results, as apparent to a person skilled in the art.

The at least one bolt (49) may come in various shapes and forms. For example, the at least one bolt (49) may have a substantially circular cross-sectional profile, a substantially oblong cross-sectional profile, a substantially rectangular cross-sectional profile, a substantially square cross-sectional profile, and/or any other appropriate cross-sectional profile.

Preferably, the corresponding hole (51) associated with the support frame (7) has a cross-sectional profile being greater than that of the at least one bolt (49) for receiving said at least one bolt (49) into the hole (51), and the hole (51) associated with the support frame (7) has a cross-sectional profile being complementary in shape to the cross-sectional profile of the at least one bolt (49). Optionally, at least one (and/or both) of the cross-sectional profile of the hole (51) associated with the support frame (7) and the cross-sectional profile of the at least one bolt (49) has rounded edges (31) for allowing a certain tolerance during an insertion of the at least one bolt (49) into the hole (51) when the blocking assembly (11) is operated into the second configuration.

As can be easily understood from the accompanying figures, the spindle (15) includes a hollow interior (15i) for receiving and containing the at least one bolt (49) therein when the at least one bolt (49) is operated in the retracted position.

According to a possible embodiment and as exemplified in the figures, the at least one bolt (49) may include a plurality of bolts (49), and the bolts (49) may be operatively extendable through corresponding slots (55) operatively provided circumferentially about the spindle (15), for instance.

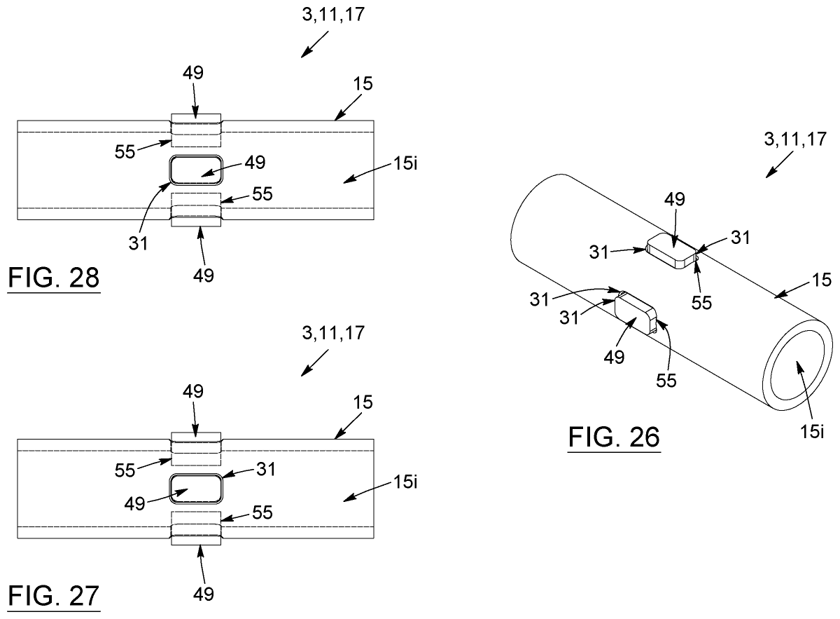

As mentioned earlier, the bolts (49) may come in various shapes and forms, but it is worth mentioning also that the bolts (49) may be disposed about the spindle (15) in various different manners as well, depending on the particular applications which the present anti-theft system (3) is intended for, and the desired end results, for the bicycle sub-assembly (1) (and/or resulting bicycle (5)). For instance, and as exemplified in FIGS. 26-28, the bolts (49) may be provided equidistantly with respect to each other about the spindle (15). Alternatively, and as better shown in FIGS. 22-25, the bolts (49) can be provided side-by-side with respect to each other about the spindle (15). Optionally also, the bolts (49) could be provided in an angularly “offset” manner with respect to each other along the length of the spindle (15). In each of these different possible embodiments, the bolts (49) being used may all have a same cross-sectional profile, or alternatively, the bolts (49) may have different cross-sectional profiles, and/or a combination of both.

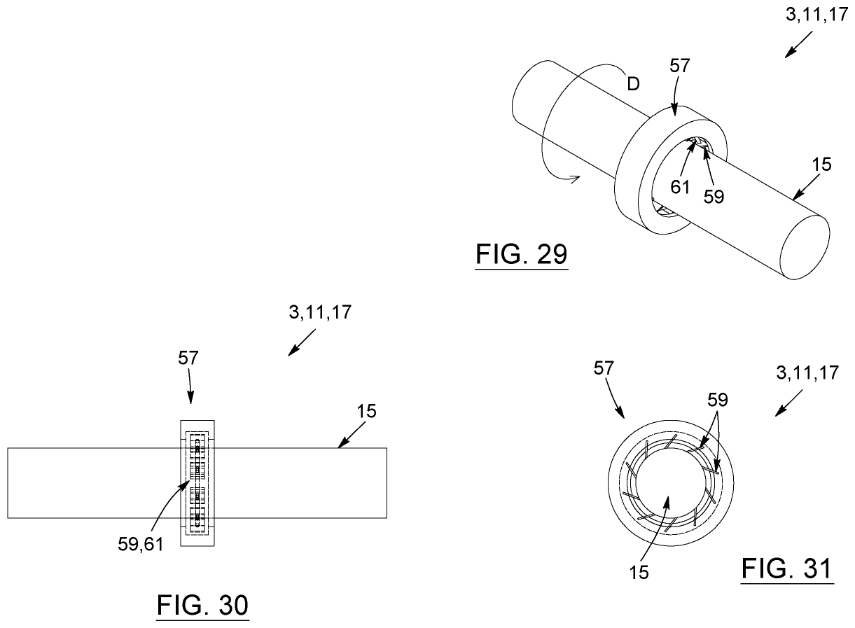

As can be easily understood when referring to FIGS. 29-31, and according to another possible embodiment of the present anti-theft system (3), the at least one blocking mechanism (17) of the blocking assembly (11) includes a ratchet mechanism (57) capable of rotating along one single direction of rotation (D), the rachet mechanism being operatively mounted about the spindle (15) and having at least one pawl element (59) for engaging with at least one corresponding abutment component (61) operatively provided about the support frame (7), thereby allowing the spindle (15) to rotate within the corresponding bore (13) associated with the support frame (7) along its intended mode when the ratchet mechanism (57) is rotated along its single direction of rotation, and preventing the spindle (15) from rotating with respect to the corresponding bore (13) associated with the support frame (7) when the ratchet mechanism (57) is rotated in a direction contrary to its single direction of rotation.

Optionally, the ratchet mechanism (57) may be operatively mounted about the spindle (15), and the at least one corresponding abutment component (61) is operatively provided about the support frame (7). Optionally also, the ratchet mechanism (57) may include a plurality of pawl elements (59) operatively disposed circumferentially about the spindle (15), and/or the ratchet mechanism (57) may include a plurality of abutment components (61) operatively disposed circumferentially within the corresponding bore (13) associated with the support frame (7).

Alternatively, the ratchet mechanism (57) may be operatively mounted about the support frame (7), and the at least one corresponding abutment component (61) may be operatively provided about the spindle (15). Similarly to the above, the ratchet mechanism (57) may include a plurality of pawl elements (59) operatively disposed circumferentially within the corresponding bore (13) associated with the support frame (7), and/or the ratchet mechanism (57) may include a plurality of abutment components (61) operatively disposed circumferentially about the spindle (15).

According to a possible embodiment, the at least one pawl element (59) and the at least one corresponding abutment component (61) of the ratchet mechanism (57) can be positioned, shaped and sized with respect to each other so to prevent the spindle (15) from rotating with respect to the corresponding bore (13) associated with the support frame (7) along its intended mode when left and right crankarms (27a,27b) of the bicycle (5) are disposed in a substantially vertical manner, thereby making it harder (or even “impossible”) for an unauthorized user of the bicycle (5) to use a torque/moment of own weight on the pedal(s) of the bicycle (5), for example, to try to overcome or break the blocking action provided by the ratchet mechanism (57), thereby further providing the bicycle (5) (and/or corresponding sub-assembly (3)), with an additional anti-theft protection.

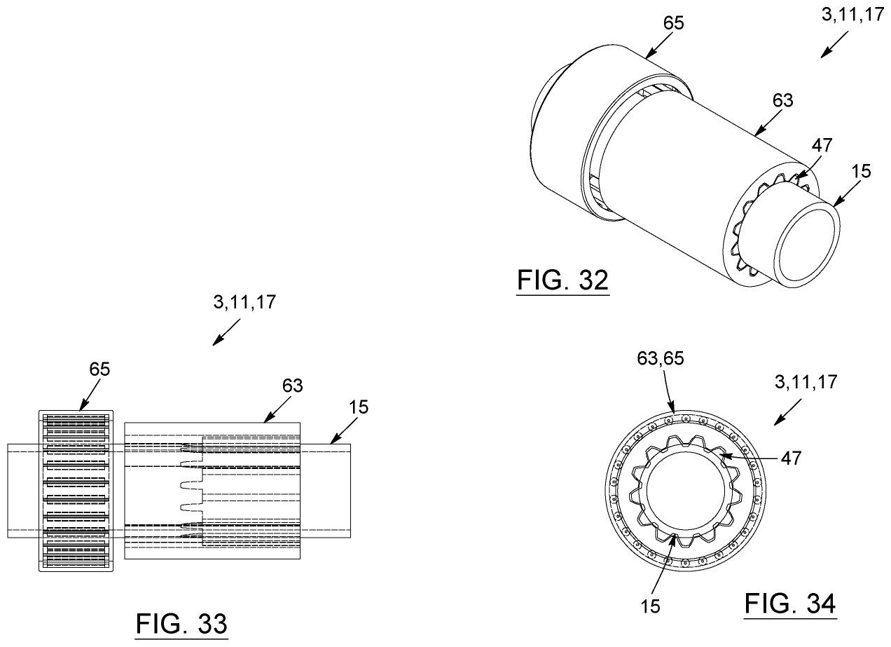

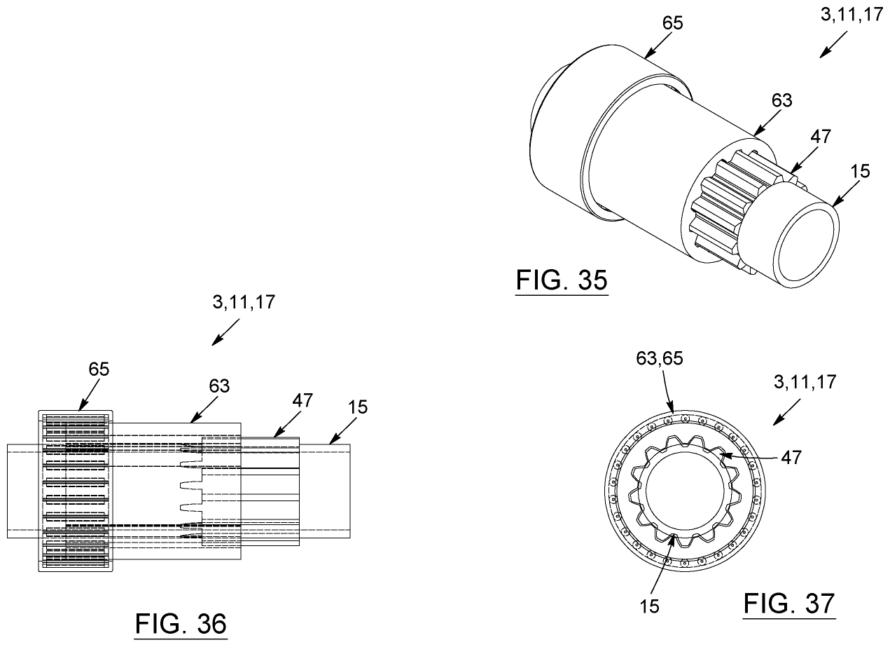

As can be easily understood when referring to FIGS. 32-37, and according to another possible embodiment of the present anti-theft system (3), the at least one blocking mechanism (17) of the blocking assembly (11) may include at least one unidirectional bearing operatively mounted about either one of the spindle (15) and the corresponding bore (13) associated with the support frame (7), the at least one unidirectional bearing being configured to allow rotation along one single direction of rotation, the at least one unidirectional bearing having first and second bearing components (63,65) operatively mounted onto the spindle (15) and the corresponding bore (13) associated with the support frame (7) respectively, the at least one unidirectional bearing being configured so that when the blocking assembly (11) is operated in the first configuration, the bearing component (63) of the spindle (15) is longitudinally drawn away from the bearing component (65) of the corresponding bore (13) associated with the support frame (7), thereby allowing the spindle (15) to rotate within the corresponding bore (13) associated with the support frame (7) along its intended mode, and the at least one unidirectional bearing being further configured so that when the blocking assembly (11) is operated into the second configuration, the bearing component (63) of the spindle (15) is longitudinally brought to interact with the bearing component (65) of the corresponding bore (13) associated with the support frame (7), thereby preventing the spindle (15) from rotating with respect to the corresponding bore (13) associated with the support frame (7) along its intended mode, due to an effect of the at least one unidirectional bearing.

Similarly to the above-discussed, the first and second bearing components (63,65) of the least one unidirectional bearing can be positioned, shaped and sized with respect to each other so to prevent the spindle (15) from rotating with respect to the corresponding bore (13) associated with the support frame (7) along its intended mode when left and right crankarms (27a,27b) of the bicycle (5) are disposed in a substantially vertical manner, thereby making it harder (or even “impossible”) for an unauthorized user of the bicycle (5) to use a torque/moment of own weight on the pedal(s) of the bicycle (5), for example, to try to overcome or break the blocking action provided by the unidirectional bearing and associated bearing components (63,65), thereby further providing the bicycle (5) (and/or corresponding sub-assembly (3)), with an additional anti-theft protection.

According to a possible embodiment, the at least one unidirectional bearing includes a pair of unidirectional bearings operatively mounted about either one of the spindle (15) and the corresponding bore (13) associated with the support frame (7), the unidirectional bearings being configured to allow rotation along opposite directions of rotation, each of the unidirectional bearings having first and second bearing components (63,65) operatively mounted onto the spindle (15) and the corresponding bore (13) associated with the support frame (7) respectively, the pair of unidirectional bearings being configured so that when the blocking assembly (11) is operated in the first configuration, the bearing components (63,65) of the spindle (15) are longitudinally drawn away from the bearing components (65,63) of the corresponding bore (13) associated with the support frame (7), thereby allowing the spindle (15) to rotate within the corresponding bore (13) associated with the support frame (7) along its intended mode, and the pair of unidirectional bearings being further configured so that when the blocking assembly (11) is operated into the second configuration, the bearing components (63,65) of the spindle (15) are longitudinally brought to interact with the bearing components (65,63) of the corresponding bore (13) associated with the support frame (7), thereby preventing the spindle (15) from rotating with respect to the corresponding bore (13) associated with the support frame (7), due to a resulting effect of the pair of unidirectional bearings having opposite directions of rotation.

Optionally also, the first and second bearing components (63,65) may cooperate with corresponding splines (47) operatively provided about the spindle (15) and/or with any other appropriate means for ensuring an operation between first and second configurations of the blocking assembly (11) (i.e. between “engaged” and “disengaged” configurations of the anti-theft system (3)). Indeed, and as explained earlier, the present anti-theft system (3) contemplates any other assembly allowing a proper “relative motion” (ex. movement, displacement, positioning, repositioning, angular adjustment, alignment, etc.) between different parts of the anti-theft system (3) for allowing an proper operation of its blocking assembly (11) and its associated at least one blocking mechanism (17) between the first and second configurations, irrespectively of the nature of the at least one blocking mechanism (17) being used, given that the at least one blocking mechanism (17) can come in various shapes and forms, as described and/or alluded to herein, as well as exemplified in the accompanying drawings, and as apparent to a person skilled in the art.

As can be easily understood from the aforementioned and the accompanying drawings, rotation of the spindle (15) within the corresponding bore (13) associated with the support frame (7) along the intended mode of the bicycle can correspond to at least a “frontward” motion of the bicycle (5), either via a corresponding rotation (ex. “frontward” rotation) of the spindle (15) and associated pedals (73), or via a corresponding motorized assembly and/or other “power/pedal assistance” assembly of the bicycle (5), selectively being cooperable with the pedal assembly (71). Indeed, a “frontward” motion of the bicycle (5) is usually an “intended use” for the bicycle (5). However, it worth mentioning that the present anti-theft system (5) can be designed so that it enables a “rearward” motion of the bicycle as well (or at least, a rearward rotation of the spindle, etc.), depending on the particular applications which the bicycle (5) is intended for, and the desired end results.

As can also be easily understood from the aforementioned and the accompanying drawings, the anti-theft system (3) is intended to have a blocking assembly (11) with at least one blocking mechanism (17) operatively interacting (either directly and/or indirectly) with the spindle (15) to prevent said spindle (15) from rotating within the corresponding bore (13) associated with the support frame (7) along the aforementioned intended mode of the bicycle (5), when the blocking assembly (11) is selectively operable by an authorized user into the second configuration, and it is worth mentioning also that in the context of the present description, “to prevent said spindle from rotating within the corresponding bore associated with the support frame along the aforementioned intended mode of the bicycle” can include a series of different possibilities. Namely, it may include a direct and immediate blocking of the spindle (15), thereby preventing the resulting bicycle (5) from being used, and/or, it may also include changing (either directly and/or indirectly, mechanically and/or via any other appropriate means) the nature of the rotation of the spindle (15), making the use of the bicycle (5) extremely difficult and/or nearly “impossible” for an unauthorized user. Indeed, when triggered into the second configuration (i.e. “anti-theft” or “locked” or “secured” configuration, for example), the anti-theft system (5) could be designed and configured to cooperate with the spindle (5) so to as provide it with an increased and/or very high resistance, making use of the bicycle (5) extremely difficult and/or nearly “impossible” for an unauthorized user. Alternatively, when triggered into the second configuration (i.e. “anti-theft” or “locked” or “secured” configuration, for example), the anti-theft system (5) could be designed and configured to cooperate with the spindle (5) so to as provide it with a very low and/or “free-turning” resistance (similarly to one using a gear-ratio for climbing steep hills, but used for a flat surface), making use of the bicycle (5) extremely inefficient for an unauthorized user. Optionally also, when triggered into the second configuration (i.e. “anti-theft” or “locked” or “secured” configuration, for example), the anti-theft system (5) could be designed and configured to cooperate with the spindle (5) so to effectively disengage its corresponding pedal assembly (71) and/or corresponding driving gear(s) from a corresponding driving/transmission assembly operatively connected to the wheel(s) (69) of the bicycle (5). Thus, the present anti-theft system (3) could also ultimately be integrated into such a driving/transmission assembly, and/or other “power/pedal assistance” assembly of the bicycle (5), as can be easily understood by a person skilled in the art, and such an assembly with integrated anti-theft system (5) could also have a corresponding authentication mechanism (19) and/or activation mechanism (21), as can also be easily understood by a person skilled in the art.

As can also be easily understood from the aforementioned and the accompanying drawings, the present anti-theft system (3) is advantageous, in that, contrary to conventional anti-theft devices (ex. locks, etc.) that are present “outside” of the bicycle (5), and thus, are more easily visible, and more prone to breaking and/or tampering by unwanted people (ex. thieves, etc.), in the present case, and according to a possible embodiment, the anti-theft system (3) has a blocking assembly (11) which is encased into a corresponding portion of the support frame (7), adjacent to the spindle (15) of the bicycle (5). Indeed, the blocking assembly (11) can be located inside a corresponding hollow portion (7i) of the support frame (7), adjacent to the spindle (15) of the bicycle (5), for example, and/or the blocking assembly (11) could simply be located inside a corresponding tube (67) (ex. seat tube, down tube, chain tube, etc.) of the support frame (7), adjacent to the spindle (15) of the bicycle (5), thereby further providing the bicycle (5) (and/or corresponding sub-assembly (3)), with an additional anti-theft protection, because among various other advantages, the components of the present anti-theft system (3) are meant to “not be exposed”.

According to another aspect of the present invention, there is provided a bicycle (5) with an integrated anti-theft system (3). The bicycle (5) may comprise a support frame (7) for operatively receiving at least one corresponding constituting component (9) of the bicycle, including front and rear wheels (69a,69b) being pivotally mounted respectively onto front and rear portions of the support frame (7). The bicycle (5) may also comprise a pedal assembly (71) operatively mounted about the support frame (7) and being operatively connectable to one of the wheels (69a,69b) for driving the bicycle (5), the pedal assembly (71) having left and right crankarms (27a,27b) and associated pedals (73a,73b), and a corresponding spindle (15) operatively interconnecting the left and right crankarms (27a,27b) and associated pedals (73a,73b), the spindle (15) being rotatably mounted onto a corresponding bore (13) associated with the support frame (7). The bicycle (5) may also comprise a blocking assembly (11) being operatively mounted onto the support frame (7), adjacent to the corresponding bore (13) associated with the support frame (7) for receiving the corresponding spindle (15) of the bicycle (5), the blocking assembly (11) having at least one blocking mechanism (17) being operatively cooperable with said spindle (15), the blocking assembly (11) being selectively operable by an authorized user of the bicycle (5) between a first configuration where the at least one blocking mechanism (17) allows the spindle (15) to rotate within the corresponding bore (13) associated with the support frame (7) along an intended mode of the bicycle, and a second configuration where the at least one blocking mechanism (17) operatively interacts with the spindle (15) to prevent said spindle (15) from rotating within the corresponding bore (13) associated with the support frame (7) along the aforementioned intended mode of the bicycle (5), so as to impede an unauthorized use of the bicycle (5).

According to a possible embodiment, the bicycle (5) may comprise a transmission assembly (75) operatively cooperable between at least one wheel (69) of the front and rear wheels (69a,69b), and the pedal assembly (71), for transmitting a driving force from the pedal assembly (71) to said at least one wheel (69).

In the case of a “motorized” (and/or “power-assisted”) bicycle (5), the driving force may provided by a motorized assembly (77) (and/or some other source of “power/pedal assistance”) of the bicycle (5), said motorized assembly (77) being selectively cooperable with the pedal assembly (71), as can be easily understood by a person skilled in the art.

Depending on the type of bicycle (5) with which the present anti-theft system (5) is intended for, the pedal assembly (71) may come in various shapes and forms, but as way of example(s), may be a pedal assembly (71) selected from the group consisting of a mechanical pedal assembly (71), an electrical pedal assembly (71), an electromechanical pedal assembly (71), an electronic pedal assembly (71), a computer pedal assembly (71), a software pedal assembly (71), and/or a combination of said pedal assemblies (71).

Similarly, and because bicycles (5) may come in various shapes and forms, with all kind of different components and/or accessories, the at least one corresponding constituting component (9) of the bicycle (5) according to the present case may be selected from a group of constituting components (9) consisting of an axle, a bar end, a bar plug, a basket, a bearing, a bell, a belt-drive, a bicycle brake cable, a bottle cage, a bottom bracket, a brake, a brake lever, a brake shifter, a braze-on, a cable guide, a cable, a cartridge bearing, a cassette, a coaster brake, a chain, a chainguard, a chainring, a chainset, a chainstay, a chain tensioner, a chaintug, a cluster, a cogset, a cone, a cotter, a coupler, a crankset, a cup, a cyclocomputer, a derailleur hanger, a derailleur, a down tube, a dropout, a dustcap, a dynamo, an eyelet, an electronic gear-shifting system, a fairing, a fender, a ferrule, a fork, a fork end, a frame, a freehub, a freewheel, a gusset, a hanger, a handlebar, a handlebar plug, a handlebar tape, a head badge, a head tube, a headset, a hood, a hub, a hub dynamo, a hub gear, an indicator, an inner tube, a jockey wheel, a kickstand, a lawyer tab, a locknut, a lockring, a lug, a luggage carrier, a master link, a nipple, a pannier, a pedal, a peg, a portage strap, a quick release, a rack, a reflector, a removable training wheel, a rim, a rotor, a safety lever, a saddle, a seat rail, a seat lug, a seat tube, a seat bag, a seatpost, a seatstay, a shaft-drive, a shifter, a shock absorber, a side view mirror, a skirt guard, a spindle (15), a spoke, a speaker, a sprocket, a steerer tube, a stem, a tire, a toe clip, a top tube, a valve stem, a wheel, and a wingnut.

Preferably, the at least one corresponding constituting component (9) includes a plurality of components selected from said group of constituting components (9), the plurality of constituting components (9) being combined and assembled with respect to one another in order to provide a fully-assembled and fully-operational bicycle (5), depending on the particular applications which the bicycle (5) is intended for, and the desired end results.

According to another aspect of the present invention, there is provided an anti-theft system (3) to be integrated onto a corresponding bicycle sub-assembly (1) of a corresponding resulting bicycle (5), and for providing said bicycle (5) with an integrated anti-theft capability, the anti-theft system (3) comprising a blocking assembly (11) being operatively mountable onto the support frame (7) of the bicycle sub-assembly (1), adjacent to a corresponding bore (13) associated with the support frame (7) for receiving a corresponding spindle (15) of the bicycle, the blocking assembly (11) having at least one blocking mechanism (17) being operatively cooperable with said spindle (15), the blocking assembly (11) being selectively operable by an authorized user between a first configuration where the at least one blocking mechanism (17) allows the spindle (15) to rotate within the corresponding bore (13) associated with the support frame (7) along an intended mode of the bicycle, and a second configuration where the at least one blocking mechanism (17) operatively interacts with the spindle (15) to prevent said spindle (15) from rotating within the corresponding bore (13) associated with the support frame (7) along the aforementioned intended mode of the bicycle (5), so as to impede an unauthorized use of the bicycle (5).

As can also be easily understood from the aforementioned and the accompanying drawings, the anti-theft system (3) may include one and/or several of the components and features described in the present patent specification and/or illustrated in the accompanying drawings, including, but not limited to: an authentication mechanism (19) for recognizing the authorized user and for allowing said authorized user to operate the bicycle (5) and the corresponding blocking assembly (11) thereof; an activation mechanism (21) to allow the authorized user to selectively operate the blocking assembly (11) between the first and second configurations; a latch (23) and corresponding recess (25); male and female components (33,35); a biasing assembly (37); a coupling assembly (41); at least one bolt (49) and corresponding hole (51); a ratchet mechanism (57); at least one unidirectional bearing; a spindle (15) having a hollow interior (15i) and/or provided with a recess (25); mounting component (29); etc.

It is worth mentioning also that all of the various embodiments described and/or alluded to in the present patent specification, and/or illustrated in the accompanying drawings, for the present antic-theft system (3) are not meant to be considered “mutually exclusive”, but rather, one and/or several of the components and features of these different embodiments could be combined into a single and hybridized embodiment, depending on the particular applications which the present anti-theft system (3) (and corresponding bicycle (5)) is(are) intended for, and the desired end results, as apparent to a person skilled in the art.

Furthermore, and as mentioned earlier, the present anti-theft system (3) is advantageous over conventional anti-theft devices (ex. locks, etc.) that are present “outside” of the bicycle (5), because, according to a possible embodiment, the present anti-theft system (3) has a blocking assembly (11) which is encased into a corresponding portion of the support frame (7), such as inside a corresponding hollow portion (7i) of the support frame (7), and/or inside a corresponding tube (67) (ex. seat tube, down tube, chain tube, etc.) of the support frame (7), for example, thereby preventing the components of the anti-theft system (3) from being “exposed” to unwanted people (ex. thieves, etc.), thereby further providing the bicycle (5) (and/or corresponding sub-assembly (3)), with an additional anti-theft capability.

The present anti-theft system (3) is also advantageous in that it is meant to be easily installed on new bicycles (5) and/or retrofitted on existing bicycles (5). Indeed, the different embodiments discussed herein enable the blocking assembly (11) to be easily inserted into a corresponding inner portion of the support frame (7), for example, such as inside a corresponding hollow portion (7i) of the support frame (7), and/or inside a corresponding tube (67) (ex. seat tube, down tube, chain tube, etc.) of the support frame (7), for example, or even inside a corresponding motorized assembly and/or other “power/pedal assistance” assembly of the bicycle (5), thereby further preventing the components of the anti-theft system (3) from being “exposed” to unwanted people (ex. thieves, etc.).

Other possible aspect(s), object(s), embodiment(s), variant(s), and/or resulting advantage(s) of the anti-theft system (3), all being preferred and/or optional, are briefly explained hereinbelow, and can be easily understood and/or inferred from the accompanying drawings, as well.

For example, and according to another possible aspect of the present invention, there is also provided a kit with components for assembling a fully-assembled and fully-operational anti-theft system (3) such as the one described and/or alluded to in the present patent specification, and/or illustrated in the accompanying drawings. According to yet another possible aspect of the present invention, there is also provided a vehicle (whether it's a bicycle (5) and/or something else) provided with such as an anti-theft system (3). According to yet another possible aspect of the present invention, there is also provided an assembly, sub-assembly (1), frame (7) and/or corresponding integrated anti-theft system (3) for use with a corresponding resulting vehicle (ex. bicycle (5), etc.), given that the frame (7) and/or corresponding integrated anti-theft system (3) could also ultimately be commercialized (ex. “sold”, etc.) separately and independently from the corresponding resulting vehicle (ex. bicycle (5), etc.) and associated wheel(s) (69), the frame (7) and/or corresponding integrated anti-theft system (3) having one and/or several of the various components and/or features described and/or alluded to in the present patent specification, and/or illustrated in the accompanying drawings. According to yet another possible aspect of the present invention, there is also provided a kit with components for assembling such a resulting vehicle (ex. bicycle (5), etc.), with or without associated wheel(s) (69). According to yet another possible aspect of the present invention, there is also provided a kit with components for use (ex. for mounting, assembling, manufacturing, retrofitting, upgrading, etc.) an assembly, a sub-assembly (1) and/or a frame (7) with integrated anti-theft system (3), of such a resulting vehicle (ex. bicycle (5), etc.).

As may now be appreciated, the present invention is a substantial improvement over the anti-theft systems of the prior art in that, by virtue of its design and components, as briefly explained herein, the present system enables to overcome or at least minimize some of the known drawbacks associated with conventional systems, providing for a simpler, easier, faster, more accurate, more effective, more functional, more reliable and/or more versatile anti-theft system than what is possible with other conventional systems.

Indeed, and as may now be better appreciated, the present system, among various other advantages, enables three major functions, namely: a) blocking the rotation of the spindle movement; b) blocking the disassembly when locked, mostly by blocking the axial translation; and c) blocking the pedals in a near-vertical orientation to reduce the torque applied.

The present anti-theft system (3) and corresponding parts are preferably made of substantially rigid materials, such as metallic materials, hardened polymers, composite materials, polymeric materials (ex. seals, etc.), and/or the like, so as to ensure a proper operation thereof depending on the particular applications for which the anti-theft system (3) is intended and the different parameters (forces, loads, moments, torques, etc.) in cause, as apparent to a person skilled in the art.

Of course, and as can be easily understood by a person skilled in the art, the scope of the claims should not be limited by the possible embodiments set forth in the examples, but should be given the broadest interpretation consistent with the description as a whole.

Furthermore, although preferred embodiments of the present invention have been briefly described herein and illustrated in the accompanying drawings, it is to be understood that the invention is not limited to these embodiments and that various changes and modifications could be made without departing form the scope and spirit of the present invention, as defined in the appended claims and as apparent to a person skilled in the art.

1. A bicycle sub-assembly (1) with integrated anti-theft system (3) for use with a corresponding bicycle (5), for providing said bicycle (5) with an integrated anti-theft capability, the bicycle sub-assembly (1) comprising:
a support frame (7) for operatively receiving at least one corresponding constituting component (9) of the bicycle; and
a blocking assembly (11) being operatively mountable onto the support frame (7), adjacent to a corresponding bore (13) associated with the support frame (7) for receiving a corresponding spindle (15) of the bicycle (5), the blocking assembly (11) having at least one blocking mechanism (17) being operatively cooperable with said spindle (15), the blocking assembly (11) being selectively operable by an authorized user of the bicycle (5) between a first configuration where the at least one blocking mechanism (17) allows the spindle (15) to rotate within the corresponding bore (13) associated with the support frame (7) along an intended mode of the bicycle (5), and a second configuration where the at least one blocking mechanism (17) operatively interacts with the spindle (15) to prevent said spindle (15) from rotating within the corresponding bore (13) associated with the support frame (7) along the aforementioned intended mode of the bicycle (5), so as to impede an unauthorized use of the bicycle (5).

2. A bicycle sub-assembly (1) with integrated anti-theft system (3) according to claim 1, wherein the blocking assembly (11) is provided with an authentication mechanism (19) for recognizing the authorized user of the bicycle (5) and for allowing said authorized user to operate the bicycle (5) and the corresponding blocking assembly (11) thereof.

3. A bicycle sub-assembly (1) with integrated anti-theft system (3) according to claim 2, wherein the authentication mechanism (19) is an authentication mechanism (19) selected from the group consisting of a mechanical authentication mechanism (19), an electrical authentication mechanism (19), an electromechanical authentication mechanism (19), an electronic authentication mechanism (19), a computer authentication mechanism (19), a software authentication mechanism (19), a biometric authentication mechanism (19), a remote internet-based authentication mechanism (19), and a combination of said authentication mechanisms (19).

4. A bicycle sub-assembly (1) with integrated anti-theft system (3) according to any one of claims 1-3, wherein the blocking assembly (11) is provided with an activation mechanism (21) to allow the authorized user of the bicycle to selectively operate the blocking assembly (11) between the first and second configurations.

5. A bicycle sub-assembly (1) with integrated anti-theft system (3) according to claim 4, wherein the activation mechanism (21) is an activation mechanism (21) selected from the group consisting of a mechanical activation mechanism (21), an electrical activation mechanism (21), an electromechanical activation mechanism (21), an electronic activating mechanism, a computer activation mechanism (21), a software activation mechanism (21), a biometric activation mechanism (21), a remote internet-based activation mechanism (21), and a combination of said activation mechanisms (21).

6. A bicycle sub-assembly (1) with integrated anti-theft system (3) according to any one of claims 1-5, wherein the at least one blocking mechanism (17) of the blocking assembly (11) includes a latch (23), and wherein in the first configuration of the blocking assembly (11), the latch (23) is positioned away from the spindle (15), and wherein in the second configuration of the blocking assembly (11), the latch (23) is removably inserted into a corresponding recess (25) associated with the spindle (15), for preventing the spindle (15) from rotating with respect to the corresponding bore (13) associated with the support frame (7).

7. A bicycle sub-assembly (1) with integrated anti-theft system (3) according to claim 6, wherein the latch (23) and the corresponding recess (25) associated with the spindle (15) are positioned, shaped and sized with respect to each other to prevent the spindle (15) from being longitudinally displaced and removed from its corresponding bore (13) associated with the support frame (7).

8. A bicycle sub-assembly (1) with integrated anti-theft system (3) according to claim 6 or 7, wherein the latch (23) and the corresponding recess (25) associated with the spindle (15) are positioned, shaped and sized with respect to each other so that the latch (23) is removably insertable into said recess (25) when left and right crankarms (27a,27b) of the bicycle (5) are disposed in a substantially vertical manner.

9. A bicycle sub-assembly (1) with integrated anti-theft system (3) according to any one of claims 6-8, wherein the recess (25) associated with the spindle (15) is a cut-out section operatively provided about the spindle (15).

10. A bicycle sub-assembly (1) with integrated anti-theft system (3) according to any one of claims 6-9, wherein the recess (25) associated with the spindle (15) has a circular profile.

11. A bicycle sub-assembly (1) with integrated anti-theft system (3) according to any one of claims 6-9, wherein the recess (25) associated with the spindle (15) has an oblong profile.

12. A bicycle sub-assembly (1) with integrated anti-theft system (3) according to any one of claims 6-11, wherein the recess (25) associated with the spindle (15) is positioned, shaped and sized directly onto the spindle (15) itself.

13. A bicycle sub-assembly (1) with integrated anti-theft system (3) according to any one of claims 6-11, wherein the recess (25) associated with the spindle (15) is positioned, shaped and sized onto a corresponding mounting component (29) being operatively mountable about the spindle (15).

14. A bicycle sub-assembly (1) with integrated anti-theft system (3) according to any one of claims 6-13, wherein the latch (23) has a substantially circular cross-sectional profile.

15. A bicycle sub-assembly (1) with integrated anti-theft system (3) according to any one of claims 6-13, wherein the latch (23) has a substantially oblong cross-sectional profile.

16. A bicycle sub-assembly (1) with integrated anti-theft system (3) according to any one of claims 6-13, wherein the latch (23) has a substantially rectangular cross-sectional profile.

17. A bicycle sub-assembly (1) with integrated anti-theft system (3) according to any one of claims 6-13, wherein the latch (23) has a substantially square cross-sectional profile.

18. A bicycle sub-assembly (1) with integrated anti-theft system (3) according to any one of claims 6-17, wherein the recess (25) associated with the spindle (15) has a cross-sectional profile being greater than that of the latch (23) for receiving said latch (23) into the recess (25).

19. A bicycle sub-assembly (1) with integrated anti-theft system (3) according to any one of claims 6-18, wherein the recess (25) associated with the spindle (15) has a cross-sectional profile being complementary in shape to the cross-sectional profile of the latch (23).

20. A bicycle sub-assembly (1) with integrated anti-theft system (3) according to claim 19, wherein at least one of the cross-sectional profile of the recess (25) associated with the spindle (15) and the cross-sectional profile of the latch (23) has rounded edges (31) for allowing a certain tolerance during an insertion of the latch (23) into the recess (25) associated with the spindle (15) when the blocking assembly (11) is operated into the second configuration.

21. A bicycle sub-assembly (1) with integrated anti-theft system (3) according to any one of claims 1-20, wherein the at least one blocking mechanism (17) of the blocking assembly (11) includes male and female components (33,35), one of said male and female components (33,35) being operatively provided about the spindle (15), and another one of said male and female components (33,35) being operatively provided about the corresponding bore (13) associated with the support frame (7), and wherein in the first configuration of the blocking assembly (11), the male and female components (33,35) are disengaged from each other, thereby allowing the spindle (15) to rotate within the corresponding bore (13) associated with the support frame (7) along its intended mode, and wherein in the second configuration of the blocking assembly (11), the male and female components (33,35) are engaged with one another, thereby preventing the spindle (15) from rotating with respect to the corresponding bore (13) associated with the support frame (7).

22. A bicycle sub-assembly (1) with integrated anti-theft system (3) according to claim 21, wherein the at least one blocking mechanism (17) of the blocking assembly (11) includes a biasing assembly (37) for biasing the male and female components (33,35) towards one another, for an increased engagement between said male and female components (33,35), when the blocking assembly (11) is operated in the second configuration.

23. A bicycle sub-assembly (1) with integrated anti-theft system (3) according to claim 22, wherein the biasing assembly (37) includes at least one spring (39) operatively acting against at least one of the male and female components (33,35) for biasing said male and female components (33,35) towards one another, when the blocking assembly (11) is operated in the second configuration.

24. A bicycle sub-assembly (1) with integrated anti-theft system (3) according to any one of claims 21-23, wherein the male and female components (33,35) are provided onto a coupling assembly (41) having first and second coupling components (43,45), a first coupling component (43) being operatively mounted about the spindle (15), and the second coupling component (45) being operatively mounted about the corresponding bore (13) associated with the support frame (7).

25. A bicycle sub-assembly (1) with integrated anti-theft system (3) according to claim 24, wherein the first coupling component (43) of the coupling assembly (41) rotates with the spindle (15), and wherein the second coupling component (45) remains substantially fixed with respect to the corresponding bore (13) associated with the support frame (7).

26. A bicycle sub-assembly (1) with integrated anti-theft system (3) according to claim 24 or 25, wherein the first coupling component (43) includes at least one of the male and female components (33,35), and wherein the second coupling component (45) includes at least the other one of the male and female components (33,35).

27. A bicycle sub-assembly (1) with integrated anti-theft system (3) according to any one of claims 24-26, wherein the first coupling component (43) includes at first plurality of male and female components (33,35), and wherein the second coupling component (45) includes a second plurality of male and female components (33,35), and wherein in the first configuration of the blocking assembly (11), the male and female components (33,35) of the first plurality of male and female components (33,35) are disengaged from the male and female components (33,35) of the second plurality of male and female components (33,35), thereby allowing the spindle (15) to rotate within the corresponding bore (13) associated with the support frame (7) along its intended mode, and wherein in the second configuration of the blocking assembly (11), the male and female components (33,35) of the first plurality of male and female components (33,35) are engaged with associated components of the second plurality of male and female components (33,35), thereby preventing the spindle (15) from rotating with respect to the corresponding bore (13) associated with the support frame (7) along its intended mode.

28. A bicycle sub-assembly (1) with integrated anti-theft system (3) according to any one of claims 24-27, in combination with claim 22 or 23, wherein the biasing assembly (37) is operatively acting against at least one of the first and second coupling components (43,45) for biasing said first and second coupling components (43,45) towards one another, when the blocking assembly (11) is operated in the second configuration.

29. A bicycle sub-assembly (1) with integrated anti-theft system (3) according to any one of claims 21-28, wherein the male and female components (33,35) have a substantially triangular profile.

30. A bicycle sub-assembly (1) with integrated anti-theft system (3) according to any one of claims 21-28, wherein the male and female components (33,35) have a substantially rectangular profile.

31. A bicycle sub-assembly (1) with integrated anti-theft system (3) according to any one of claims 21-28, wherein the male and female components (33,35) have a substantially square profile.

32. A bicycle sub-assembly (1) with integrated anti-theft system (3) according to any one of claims 21-31, wherein the male and female components (33,35) cooperate with corresponding splines (47) of the blocking assembly (11).

33. A bicycle sub-assembly (1) with integrated anti-theft system (3) according to any one of claims 31-32, wherein the male and female components (33,35) are positioned, shaped and sized with respect to each other so as to engageable with one another when left and right crankarms (27a,27b) of the bicycle (5) are disposed in a substantially vertical manner.

34. A bicycle sub-assembly (1) with integrated anti-theft system (3) according to any one of claims 1-33, wherein the at least one blocking mechanism (17) of the blocking assembly (11) includes at least one bolt (49) positioned inside the spindle (15), and operable between retracted and extended positions, and wherein in the first configuration of the blocking assembly (11), the at least one bolt (49) is retracted within the spindle (15), and wherein in the second configuration of the blocking assembly (11), the at least one bolt (49) is extended outwardly from the spindle (15) and removably insertable into a corresponding hole (51) associated with the support frame (7), for preventing the spindle (15) from rotating with respect to the corresponding bore (13) associated with the support frame (7).

35. A bicycle sub-assembly (1) with integrated anti-theft system (3) according to claim 34, wherein the at least one bolt (49) and the corresponding hole (51) associated with the support frame (7) are positioned, shaped and sized with respect to each other to prevent the spindle (15) from being longitudinally displaced and removed from its corresponding bore (13) associated with the support frame (7).

36. A bicycle sub-assembly (1) with integrated anti-theft system (3) according to claim 34 or 35, wherein the at least one bolt (49) and the corresponding hole (51) associated with the support frame (7) are positioned, shaped and sized with respect to each other so that the at least one bolt (49) is removably insertable into said hole (51) of the support frame (7) when left and right crankarms (27a,27b) of the bicycle (5) are disposed in a substantially vertical manner.

37. A bicycle sub-assembly (1) with integrated anti-theft system (3) according to any one of claims 1-36, wherein the corresponding hole (51) associated with the support frame (7) is positioned, shaped and sized directly onto the support frame (7) itself.

38. A bicycle sub-assembly (1) with integrated anti-theft system (3) according to any one of claims 1-36, wherein the corresponding hole (51) associated with the support frame (7) is positioned, shaped and sized onto a corresponding affixing component (53) being operatively mountable about the support frame (7).

39. A bicycle sub-assembly (1) with integrated anti-theft system (3) according to any one of claims 34-38, wherein the at least one bolt (49) has a substantially circular cross-sectional profile.

40. A bicycle sub-assembly (1) with integrated anti-theft system (3) according to any one of claims 34-38, wherein the at least one bolt (49) has a substantially oblong cross-sectional profile.

41. A bicycle sub-assembly (1) with integrated anti-theft system (3) according to any one of claims 34-38, wherein the at least one bolt (49) has a substantially rectangular cross-sectional profile.

42. A bicycle sub-assembly (1) with integrated anti-theft system (3) according to any one of claims 34-38, wherein the at least one bolt (49) has a substantially square cross-sectional profile.

43. A bicycle sub-assembly (1) with integrated anti-theft system (3) according to any one of claims 34-42, wherein the corresponding hole (51) associated with the support frame (7) has a cross-sectional profile being greater than that of the at least one bolt (49) for receiving said at least one bolt (49) into the hole (51).

44. A bicycle sub-assembly (1) with integrated anti-theft system (3) according to any one of claims 34-43, wherein the hole (51) associated with the support frame (7) has a cross-sectional profile being complementary in shape to the cross-sectional profile of the at least one bolt (49).

45. A bicycle sub-assembly (1) with integrated anti-theft system (3) according to claim 44, wherein at least one of the cross-sectional profile of the hole (51) associated with the support frame (7) and the cross-sectional profile of the at least one bolt (49) has rounded edges (31) for allowing a certain tolerance during an insertion of the at least one bolt (49) into the hole (51) when the blocking assembly (11) is operated into the second configuration.

46. A bicycle sub-assembly (1) with integrated anti-theft system (3) according to any one of claims 34-45, wherein the spindle (15) includes a hollow interior (15i) for receiving and containing the at least one bolt (49) therein when the at least one bolt (49) is operated in the retracted position.

47. A bicycle sub-assembly (1) with integrated anti-theft system (3) according to any one of claims 34-46, wherein the at least one bolt (49) includes a plurality of bolts (49).

48. A bicycle sub-assembly (1) with integrated anti-theft system (3) according to claim 47, wherein the bolts (49) are operatively extendable through corresponding slots (55) operatively provided circumferentially about the spindle (15).

49. A bicycle sub-assembly (1) with integrated anti-theft system (3) according to claim 47 or 48, wherein the bolts (49) are provided equidistantly with respect to each other about the spindle (15).

50. A bicycle sub-assembly (1) with integrated anti-theft system (3) according to claim 47 or 48, wherein the bolts (49) are provided side-by-side with respect to each other about the spindle (15).

51. A bicycle sub-assembly (1) with integrated anti-theft system (3) according to any one of claims 47-50, wherein each of the bolts (49) has a same cross-sectional profile.

52. A bicycle sub-assembly (1) with integrated anti-theft system (3) according to any one of claims 47-50, wherein the bolts (49) have different cross-sectional profiles.

53. A bicycle sub-assembly (1) with integrated anti-theft system (3) according to any one of claims 1-52, wherein the at least one blocking mechanism (17) of the blocking assembly (11) includes a ratchet mechanism (57) capable of rotating along one single direction of rotation (D), the ratchet mechanism (57) being operatively mounted about the spindle (15) and having at least one pawl element (59) for engaging with at least one corresponding abutment component (61) operatively provided about the support frame (7), thereby allowing the spindle (15) to rotate within the corresponding bore (13) associated with the support frame (7) along its intended mode when the ratchet mechanism (57) is rotated along its single direction of rotation, and preventing the spindle (15) from rotating with respect to the corresponding bore (13) associated with the support frame (7) when the ratchet mechanism (57) is rotated in a direction contrary to its single direction of rotation.

54. A bicycle sub-assembly (1) with integrated anti-theft system (3) according to claim 53, wherein the ratchet mechanism (57) is operatively mounted about the spindle (15), and wherein the at least one corresponding abutment component (61) is operatively provided about the support frame (7).

55. A bicycle sub-assembly (1) with integrated anti-theft system (3) according to claim 53 or 54, wherein the ratchet mechanism (57) includes a plurality of pawl elements (59) operatively disposed circumferentially about the spindle (15).

56. A bicycle sub-assembly (1) with integrated anti-theft system (3) according to claim 55, wherein the ratchet mechanism (57) includes a plurality of abutment components (61) operatively disposed circumferentially within the corresponding bore (13) associated with the support frame (7).

57. A bicycle sub-assembly (1) with integrated anti-theft system (3) according to claim 53, wherein the ratchet mechanism (57) is operatively mounted about the support frame (7), and wherein the at least one corresponding abutment component (61) is operatively provided about the spindle (15).

58. A bicycle sub-assembly (1) with integrated anti-theft system (3) according to claim 53 or 57, wherein the ratchet mechanism (57) includes a plurality of pawl elements (59) operatively disposed circumferentially within the corresponding bore (13) associated with the support frame (7).

59. A bicycle sub-assembly (1) with integrated anti-theft system (3) according to claim 58, wherein the ratchet mechanism (57) includes a plurality of abutment components (61) operatively disposed circumferentially about the spindle (15).

60. A bicycle sub-assembly (1) with integrated anti-theft system (3) according to any one of claims 53-59, wherein the at least one pawl element (59) and the at least one corresponding abutment component (61) of the ratchet mechanism (57) are positioned, shaped and sized with respect to each other so to prevent the spindle (15) from rotating with respect to the corresponding bore (13) associated with the support frame (7) along its intended mode when left and right crankarms (27a,27b) of the bicycle (5) are disposed in a substantially vertical manner.

61. A bicycle sub-assembly (1) with integrated anti-theft system (3) according to any one of claims 1-60, wherein the at least one blocking mechanism (17) of the blocking assembly (11) includes at least one unidirectional bearing operatively mounted about either one of the spindle (15) and the corresponding bore (13) associated with the support frame (7), the at least one unidirectional bearing being configured to allow rotation along one single direction of rotation, the at least one unidirectional bearing having first and second bearing components (63,65) operatively mounted onto the spindle (15) and the corresponding bore (13) associated with the support frame (7) respectively, the at least one unidirectional bearing being configured so that when the blocking assembly (11) is operated in the first configuration, the bearing component (63) of the spindle (15) is longitudinally drawn away from the bearing component (65) of the corresponding bore (13) associated with the support frame (7), thereby allowing the spindle (15) to rotate within the corresponding bore (13) associated with the support frame (7) along its intended mode, and the at least one unidirectional bearing being further configured so that when the blocking assembly (11) is operated into the second configuration, the bearing component (63) of the spindle (15) is longitudinally brought to interact with the bearing component (65) of the corresponding bore (13) associated with the support frame (7), thereby preventing the spindle (15) from rotating with respect to the corresponding bore (13) associated with the support frame (7) along its intended mode, due to an effect of the at least one unidirectional bearing.

62. A bicycle sub-assembly (1) with integrated anti-theft system (3) according to claim 61, wherein the first and second bearing components (63,65) of the least one unidirectional bearing are positioned, shaped and sized with respect to each other so to prevent the spindle (15) from rotating with respect to the corresponding bore (13) associated with the support frame (7) along its intended mode when left and right crankarms (27a,27b) of the bicycle (5) are disposed in a substantially vertical manner.

63. A bicycle sub-assembly (1) with integrated anti-theft system (3) according to claim 61 or 62, wherein the at least one unidirectional bearing includes a pair of unidirectional bearings operatively mounted about either one of the spindle (15) and the corresponding bore (13) associated with the support frame (7), the unidirectional bearings being configured to allow rotation along opposite directions of rotation, each of the unidirectional bearings having first and second bearing components (63,65) operatively mounted onto the spindle (15) and the corresponding bore (13) associated with the support frame (7) respectively, the pair of unidirectional bearings being further configured so that when the blocking assembly (11) is operated in the first configuration, the bearing components (63,65) of the spindle (15) are longitudinally drawn away from the bearing components (65,63) of the corresponding bore (13) associated with the support frame (7), thereby allowing the spindle (15) to rotate within the corresponding bore (13) associated with the support frame (7) along its intended mode, and the pair of unidirectional bearings being further configured so that when the blocking assembly (11) is operated into the second configuration, the bearing components (63,65) of the spindle (15) are longitudinally brought to interact with the bearing components (65,63) of the corresponding bore (13) associated with the support frame (7), thereby preventing the spindle (15) from rotating with respect to the corresponding bore (13) associated with the support frame (7), due to a resulting effect of the pair of unidirectional bearings having opposite directions of rotation.

64. A bicycle sub-assembly (1) with integrated anti-theft system (3) according to any one of claims 61-63, wherein the first and second bearing components (63,65) cooperate with corresponding splines (47) operatively provided about the spindle (15).

65. A bicycle sub-assembly (1) with integrated anti-theft system (3) according to any one of claims 1-64, wherein rotation of the spindle (15) within the corresponding bore (13) associated with the support frame (7) along the intended mode of the bicycle corresponds to a frontward motion of the bicycle (5).

66. A bicycle sub-assembly (1) with integrated anti-theft system (3) according to any one of claims 1-65, wherein the blocking assembly (11) is encased into a corresponding portion of the support frame (7), adjacent to the spindle (15) of the bicycle (5).

67. A bicycle sub-assembly (1) with integrated anti-theft system (3) according to any one of claims 1-66, wherein the blocking assembly (11) is located inside a corresponding hollow portion (7i) of the support frame (7), adjacent to the spindle (15) of the bicycle (5).

68. A bicycle sub-assembly (1) with integrated anti-theft system (3) according to any one of claims 1-67, wherein the blocking assembly (11) is located inside a corresponding tube (67) of the support frame (7), adjacent to the spindle (15) of the bicycle (5).

69. A bicycle sub-assembly (1) with integrated anti-theft system (3) according to claim 68, wherein the corresponding tube (67) of the support frame (7) is selected from the group consisting of seat tube, down tube and chain tube.

70. A kit with components for assembling a bicycle sub-assembly (1) with integrated anti-theft system (3) according to any one of claims 1-69.

71. A bicycle (5) with integrated anti-theft system (3), the bicycle (5) comprising:
a support frame (7) for operatively receiving at least one corresponding constituting component (9) of the bicycle, including front and rear wheels (69a,69b) being pivotally mounted respectively onto front and rear portions of the support frame (7);
a pedal assembly (71) operatively mounted about the support frame (7) and being operatively connectable to one of the wheels (69a,69b) for driving the bicycle (5), the pedal assembly (71) having left and right crankarms (27a,27b) and associated pedals (73a,73b), and a corresponding spindle (15) operatively interconnecting the left and right crankarms (27a,27b) and associated pedals (73a,73b), the spindle (15) being rotatably mounted onto a corresponding bore (13) associated with the support frame (7); and
a blocking assembly (11) being operatively mounted onto the support frame (7), adjacent to the corresponding bore (13) associated with the support frame (7) for receiving the corresponding spindle (15) of the bicycle (5), the blocking assembly (11) having at least one blocking mechanism (17) being operatively cooperable with said spindle (15), the blocking assembly (11) being selectively operable by an authorized user of the bicycle (5) between a first configuration where the at least one blocking mechanism (17) allows the spindle (15) to rotate within the corresponding bore (13) associated with the support frame (7) along an intended mode of the bicycle, and a second configuration where the at least one blocking mechanism (17) operatively interacts with the spindle (15) to prevent said spindle (15) from rotating within the corresponding bore (13) associated with the support frame (7) along the aforementioned intended mode of the bicycle (5), so as to impede an unauthorized use of the bicycle (5).

72. A bicycle (5) with integrated anti-theft system (3) according to claim 71, wherein the bicycle comprises a transmission assembly (75) operatively cooperable between at least one wheel (69) of the front and rear wheels (69a,69b), and the pedal assembly (71), for transmitting a driving force from the pedal assembly (71) to said at least one wheel (69).

73. A bicycle (5) with integrated anti-theft system (3) according to claim 72, wherein the driving force is provided by a motorized assembly (77) of the bicycle (5), said motorized assembly (77) being selectively cooperable with the pedal assembly (71).

74. A bicycle (5) with integrated anti-theft system (3) according to any one of claims 71-73, wherein the pedal assembly (71) is a pedal assembly (71) selected from the group consisting of a mechanical pedal assembly (71), an electrical pedal assembly (71), an electromechanical pedal assembly (71), an electronic pedal assembly (71), a computer pedal assembly (71), a software pedal assembly (71), and a combination of said pedal assemblies (71).

75. A bicycle (5) with integrated anti-theft system (3) according to any one of claims 71-74, wherein the at least one corresponding constituting component (9) of the bicycle is selected from a group of constituting components (9) consisting of an axle, a bar end, a bar plug, a basket, a bearing, a bell, a belt-drive, a bicycle brake cable, a bottle cage, a bottom bracket, a brake, a brake lever, a brake shifter, a braze-on, a cable guide, a cable, a cartridge bearing, a cassette, a coaster brake, a chain, a chainguard, a chainring, a chainset, a chainstay, a chain tensioner, a chaintug, a cluster, a cogset, a cone, a cotter, a coupler, a crankset, a cup, a cyclocomputer, a derailleur hanger, a derailleur, a down tube, a dropout, a dustcap, a dynamo, an eyelet, an electronic gear-shifting system, a fairing, a fender, a ferrule, a fork, a fork end, a frame, a freehub, a freewheel, a gusset, a hanger, a handlebar, a handlebar plug, a handlebar tape, a head badge, a head tube, a headset, a hood, a hub, a hub dynamo, a hub gear, an indicator, an inner tube, a jockey wheel, a kickstand, a lawyer tab, a locknut, a lockring, a lug, a luggage carrier, a master link, a nipple, a pannier, a pedal, a peg, a portage strap, a quick release, a rack, a reflector, a removable training wheel, a rim, a rotor, a safety lever, a saddle, a seat rail, a seat lug, a seat tube, a seat bag, a seatpost, a seatstay, a shaft-drive, a shifter, a shock absorber, a side view mirror, a skirt guard, a spindle (15), a spoke, a speaker, a sprocket, a steerer tube, a stem, a tire, a toe clip, a top tube, a valve stem, a wheel, and a wingnut.

76. A bicycle (5) with integrated anti-theft system (3) according to claim 75, wherein the at least one corresponding constituting component (9) includes a plurality of components selected from said group of constituting components (9).

77. A kit with components for assembling a bicycle (5) with integrated anti-theft system (3) according to any one of claims 71-76.

78. An anti-theft system (3) to be integrated onto a corresponding bicycle sub-assembly (1) of a corresponding resulting bicycle (5), and for providing said bicycle (5) with an integrated anti-theft capability, the anti-theft system (3) comprising:
a blocking assembly (11) being operatively mountable onto the support frame (7) of the bicycle sub-assembly (1), adjacent to a corresponding bore (13) associated with the support frame (7) for receiving a corresponding spindle (15) of the bicycle, the blocking assembly (11) having at least one blocking mechanism (17) being operatively cooperable with said spindle (15), the blocking assembly (11) being selectively operable by an authorized user between a first configuration where the at least one blocking mechanism (17) allows the spindle (15) to rotate within the corresponding bore (13) associated with the support frame (7) along an intended mode of the bicycle, and a second configuration where the at least one blocking mechanism (17) operatively interacts with the spindle (15) to prevent said spindle (15) from rotating within the corresponding bore (13) associated with the support frame (7) along the aforementioned intended mode of the bicycle (5), so as to impede an unauthorized use of the bicycle (5).

79. An anti-theft system (3) according to claim 78, wherein the blocking assembly (11) is provided with an authentication mechanism (19) for recognizing the authorized user and for allowing said authorized user to operate the bicycle (5) and the corresponding blocking assembly (11) thereof.

80. An anti-theft system (3) according to claim 79, wherein the authentication mechanism (19) is an authentication mechanism (19) selected from the group consisting of a mechanical authentication mechanism (19), an electrical authentication mechanism (19), an electromechanical authentication mechanism (19), an electronic authentication mechanism (19), a computer authentication mechanism (19), a software authentication mechanism (19), a biometric authentication mechanism (19), a remote internet-based authentication mechanism (19), and a combination of said authentication mechanisms (19).

81. An anti-theft system (3) according to any one of claims 78-80, wherein the blocking assembly (11) is provided with an activation mechanism (21) to allow the authorized user to selectively operate the blocking assembly (11) between the first and second configurations.

82. An anti-theft system (3) according to claim 81, wherein the activation mechanism (21) is an activation mechanism (21) selected from the group consisting of a mechanical activation mechanism (21), an electrical activation mechanism (21), an electromechanical activation mechanism (21), an electronic activating mechanism, a computer activation mechanism (21), a software activation mechanism (21), a biometric activation mechanism (21), a remote internet-based activation mechanism (21), and a combination of said activation mechanisms (21).

83. An anti-theft system (3) according to any one of claims 78-82, wherein the anti-theft system (3) includes a latch (23) and corresponding recess (25) such as the ones defined in any one of claims 6-20.

84. An anti-theft system (3) according to any one of claims 78-83, wherein the anti-theft system (3) includes male and female components (33,35) such as the ones defined in any one of claims 21-33.

85. An anti-theft system (3) according to any one of claims 78-84, wherein the anti-theft system (3) includes a biasing assembly (37) such as the one defined in any one of claims 22, 23 and 28.

86. An anti-theft system (3) according to any one of claims 78-85, wherein the anti-theft system (3) includes a coupling assembly (41) such as the one defined in any one of claims 24-27.

87. An anti-theft system (3) according to any one of claims 78-86, wherein the anti-theft system (3) includes at least one bolt (49) and corresponding hole (51) such as the ones defined in any one of claims 34-52.

88. An anti-theft system (3) according to any one of claims 78-87, wherein the anti-theft system (3) includes a ratchet mechanism (57) such as the one defined in any one of claims 53-60.

89. An anti-theft system (3) according to any one of claims 78-88, wherein the anti-theft system (3) includes at least one unidirectional bearing such as the one defined in any one of claims 61-64.

90. An anti-theft system (3) according to any one of claims 78-89, wherein the blocking assembly (11) is shaped and sized for encasing into a corresponding portion of the support frame (7), adjacent to the spindle (15) of the bicycle (5).

91. An anti-theft system (3) according to any one of claims 78-90, wherein the blocking assembly (11) is shaped and sized for insertion inside a corresponding hollow portion (7i) of the support frame (7), adjacent to the spindle (15) of the bicycle (5).

92. An anti-theft system (3) according to any one of claims 78-91, wherein the blocking assembly (11) is shaped and sized for insertion inside a corresponding tube (67) of the support frame (7), adjacent to the spindle (15) of the bicycle (5).

93. An anti-theft system (3) according to claim 92, wherein the corresponding tube (67) of the support frame (7) is selected from the group consisting of seat tube, down tube and chain tube.

94. An anti-theft system (3) according to any one of claims 78-93, wherein the anti-theft system (3) comprises a spindle (15) having a hollow interior (15i) for selectively containing the at least one blocking mechanism (17) of the blocking assembly (11) of the anti-theft system (3).

95. An anti-theft system (3) according to any one of claims 78-94, wherein the anti-theft system (3) comprises a spindle (15) provided with a recess (25) for selectively receiving the at least one blocking mechanism (17) of the blocking assembly (11) of the anti-theft system (3).

96. An anti-theft system (3) according to claim 95, wherein the recess (25) associated with the spindle (15) has a circular profile.

97. An anti-theft system (3) according to claim 95, wherein the recess (25) associated with the spindle (15) has an oblong profile.

98. An anti-theft system (3) according to any one of claims 95-97, wherein the recess (25) associated with the spindle (15) is positioned, shaped and sized directly onto the spindle (15) itself.

99. An anti-theft system (3) according to any one of claims 95-97, wherein the recess (25) associated with the spindle (15) is positioned, shaped and sized onto a corresponding mounting component (29) being operatively mountable about the spindle (15).
